(19) United States
(12) Patent Application Publication
(10) Pub. No.: US 2014/0207839 A1
(43) Pub. Date: Jul. 24, 2014

(54) Spatial Arithmetic Method of Integer Factorization

(71) Applicant: Sherwin Han, Portsmouth, RI (US)

(72) Inventor: Sherwin Han, Portsmouth, RI (US)

(21) Appl. No.: 14/191,384

(22) Filed: Feb. 26, 2014

Related U.S. Application Data
(63) Continuation-in-part of application No. 13/190,646, filed on Jul. 26, 2011.
(60) Provisional application No. 61/769,544, filed on Feb. 26, 2013.

(51) Int. Cl. G06F 17/10

(52) U.S. Cl. CPC G06F 17/10
USPC 708/604

(57) ABSTRACT

A computer system represents numbers as three-dimensional relations, which may be represented as collections of points in three-dimensional space. The three-dimensional representations may use values of +1 and −1 as complements of each other to overcome limitations of binary representations which use values of 1 and 0 to represent numbers. The computer system may use such three-dimensional relations to perform arithmetic and to factorize numbers.

### CROSS-REFERENCE TO RELATED APPLICATIONS

This application incorporates by reference herein U.S. Pat. No. 6,611,841, entitled, “Knowledge Acquisition and Retrieval Apparatus and Method,” issued on Aug. 26, 2003.

### BACKGROUND

Factorization is the decomposition of a number into a product of two or more other numbers, referred to as “factors.” Factorizing large integers is well-known to be a difficult problem. The discovery of new methods for increasing the efficiency of factorization, therefore, would have a significant impact on the field of mathematics generally.

### SUMMARY

A computer system represents numbers as three-dimensional relations, which may be represented as collections of points in three-dimensional space. The three-dimensional representations may use values of +1 and −1 as complements of each other to overcome limitations of binary representations which use values of 1 and 0 to represent numbers. The computer system may use such three-dimensional representations of numbers to perform arithmetic and to factorize numbers.

### BRIEF DESCRIPTION OF THE DRAWINGS

FIG. 1A illustrates a three-dimensional space which may be used to represent numbers according to embodiments of the present invention;

FIGS. 1B, 1C, and 1D illustrate three-dimensional representations of the numbers 1, 2, and 3 according to embodiments of the present invention;

FIGS. 1E-1S illustrate three-dimensional representations of the origin point and various numbers according to embodiments of the present invention;

FIGS. 1T-1V illustrate three different but equivalent three-dimensional representations of the number 15 according to embodiments of the present invention;

FIG. 1W shows an example of a three-dimensional relation which may be used to represent the number 49 according to an embodiment of the present invention;

FIG. 1X shows an example of factoring a three-dimensional representation of the number 49 into three-dimensional representations of the numbers 7 and 7 according to an embodiment of the present invention;

FIGS. 2A-2G illustrate a method for factoring a number into two factors according to one embodiment of the present invention;

FIG. 3A is an illustration of a set of partial products of two binary numbers represented in a square form according to an embodiment of the present invention;

FIG. 3B is an illustration of the set of partial products of FIG. 3A represented in a diagonal form according to an embodiment of the present invention;

FIG. 3C is an illustration of the product resulting from summing the partial products of FIG. 3B according to an embodiment of the present invention;

FIG. 3D is an illustration of the complement of the product of FIG. 3C according to an embodiment of the present invention; and

FIGS. 4A-4I illustrate a method for factorizing a product into two factors (multiplicands) according to an embodiment of the present invention.

### DETAILED DESCRIPTION

One aspect of the present invention is directed to techniques for representing three-dimensional relations. For example, according to one embodiment of the present invention a relation may be represented as a three-dimensional relation having the form of (x, y, z). Such a relation may be represented as an ordered set of three two-dimensional relations, namely: (x, y), (y, z), and (z, x). In this respect, embodiments of the present invention differ from traditional methods for representing relations, which represent relations as two-dimensional relations.

In particular, according to one embodiment of the present invention, any particular number A may be represented as a three-dimensional relation in the form of one or more ordered triplets (x_{A}, y_{A}, z_{A}). Each such triplet may represent a distinct point in three-dimensional space. As a result, any particular number A may be represented by one or more points in three dimensional space. Each such triplet may alternatively be represented as an ordered set of three two-dimensional relations: (x_{A}, y_{A}), (y_{A}, z_{A}), and (z_{A}, x_{A}). As this implies, another number B (which differs from the number A) may be represented by one or more triplets (x_{B}, y_{B}, z_{B}), each of which may alternatively be represented as an ordered set of three two-dimensional relations: (x_{B}, y_{B}), (y_{B}, z_{B}), and (z_{B}, x_{B}). More generally, any number may be represented in this manner as a three-dimensional relation.

One aspect of the present invention processes multi-dimensional relations as two inverse functions in a domain of three-dimensional nets.

Another aspect of the present invention is directed to techniques for representing numbers as binary numbers having corresponding three-dimensional relation values. For example, the x, y, and z dimensions may be mapped to the powers of 2 (i.e., 0, 1, 2, 4, 8, 16, etc.) in a repeating pattern. More specifically, an order for the x, y, and z dimensions may be selected. Such orders include the following: (1) x, y, z; (2) y, z, x; (3) z, x, y; (4) x, z, y; (5) z, y, x; and (6) y, x, z. Any of these orders may be chosen. Once such an order is chosen, the order may be repeated and the repeating sequence of dimensions may be mapped to the powers of 2. An example of such a mapping is shown below in Table 1 for the first eight powers of two. It should be appreciated, however, that such a mapping may be extended to include any number of the powers of two.

In the example of Table 1, the order x, y, z is chosen. As can be seen from Table 1, the pattern x, y, z is repeated from right to left repeatedly. In this repeating pattern, read from right to left in Table 1, x is followed by y, which is followed by z, which is followed by x, and so on.

TABLE 1

| | Bit Position | | | | | | | |
|---|---|---|---|---|---|---|---|---|
| | 8 | 7 | 6 | 5 | 4 | 3 | 2 | 1 |
| Power of 2 | 64 | 32 | 16 | 8 | 4 | 2 | 1 | 0 |
| Dimension | y | x | z | y | x | z | y | x |

Now consider any particular binary number A. Embodiments of the present invention may produce or otherwise identify a three-dimensional relation representing binary number A by mapping the bits in binary number A to dimensions using a mapping such as the one shown in Table 1, above, and then by producing a corresponding ordered set of three-dimensional relations. As an example, consider the binary number 10011010, which is overlaid on the mapping of Table 1 in Table 2, below.

TABLE 2

| | Bit Position | | | | | | | |
|---|---|---|---|---|---|---|---|---|
| | 8 | 7 | 6 | 5 | 4 | 3 | 2 | 1 |
| Power of 2 | 64 | 32 | 16 | 8 | 4 | 2 | 1 | 0 |
| Dimension | y | x | z | y | x | z | y | x |
| A | 1 | 0 | 0 | 1 | 1 | 0 | 1 | 0 |

The mapping between bits in the binary number A and the dimensions x, y, and z can be seen from Table 1. In particular, each bit in binary number A maps to the dimension that is directly above that bit in Table 2. As this example demonstrates, embodiments of the present invention may identify mappings between each bit in a binary number and one of three dimensions using a mapping such as the one shown above in Table 1. Such a mapping may be represented more concisely in the following format: 1y0x0z1y1x0z1y0x.

As will be described in more detail below, such a representation of a mapping between binary number A and the x, y, and z dimensions may be used to create a three-dimensional representation of the binary number A in a three-dimensional space. When creating such a three-dimensional representation of a binary number, for each bit in the number, a corresponding point in three-dimensional space is created. When creating a point in three-dimensional space corresponding to a particular bit, both the dimension to which that bit is mapped and the bit position of that bit are used to create the point. Therefore, to aid in the understanding of how the mapping of a binary number to dimensions is used to create a three-dimensional representation of the number, we will further refine the textual representation of the mapping by including a subscript after each dimension to represent the bit position that corresponds to the dimension. For example, we may insert such subscripts into the mapping 1y0x0z1y1x0z1y0x to create a revised mapping of 1y₈0x₇0z₆1y₅1x₄0z₃1y₂0x₁, in which each subscript represents the bit position of the corresponding bit.

Alternatively, embodiments of the present invention may represent numbers using a representation in which the primitive values of +1 (also written herein simply as 1) and −1 are used instead of the conventional binary values of 1 and 0. For example, the binary number A may first be mapped to an alternative representation in which each binary value of 1 remains unchanged and in which each binary value of 0 is replaced with the value of −1. For example, the binary value 10011010 may be represented alternatively as the value +1−1−1+1+1−1+1−1. This alternative representation, which is based on the primitive values of +1 and −1, is advantageous over the conventional use of the primitive values of +1 and 0, because the +1 and −1 are both equal in magnitude to each other (because they both have an absolute value or magnitude of 1) but opposite in direction to each other (because +1 has a positive direction and −1 has an opposite, negative direction). In contrast, the conventional binary values of +1 and 0 are neither equal in magnitude to each other nor opposite in direction to each other. (In fact, the value of 0 does not have a magnitude or direction.)

As will be described in more detail below, the use of +1 and −1 as primitive values enables numbers represented as combinations of +1 and −1 to be represented as three-dimensional points in a three-dimensional space more easily and directly than numbers represented as combinations of +1 and 0. This further facilitates use of such numbers to perform arithmetic (such as multiplication, division, addition, or subtraction), factorization, and other operations more easily than conventional binary numbers composed of primitive values of 0 and 1.

Because the use of +1 and −1 to represent numbers is new, there is no existing terminology to refer to a number which has permissible values consisting of the set {+1, −1}. The existing term “bit” refers to a number which has a range of permissible values consisting of the set {+1, 0}. For ease of explanation, and because embodiments of the present invention may use either a representation based on {+1, 0} or {+1, −1}, the term “bit” will be used herein to refer both to numbers that have a range of permissible values consisting of the set {+1, 0} and to numbers that have a range of permissible values consisting of the set {+1, −1}. Similarly, the term “binary number” will be used herein to refer to any number consisting of bits, whether such bits have a range of {+1, 0} or {+1, −1}. For example, both the number 10011010 and the number +1−1−1+1+1−1+1−1 will be referred to herein as “binary numbers,” even though the number +1−1−+1−1−1+1+1−1+1−1 does not contain “bits” in the conventional sense.

Although the number A in this particular example contains exactly eight bits, this is merely an example and does not constitute a limitation of the present invention. More generally, embodiments of the present invention may be applied to binary numbers containing any number of bits. Furthermore, embodiments of the present invention may be applied to any number that is not a binary number by first converting the number to a binary number (in which the bits have either the range {+1, 0} or {+1, −1}) and then applying the techniques disclosed herein to the binary number.

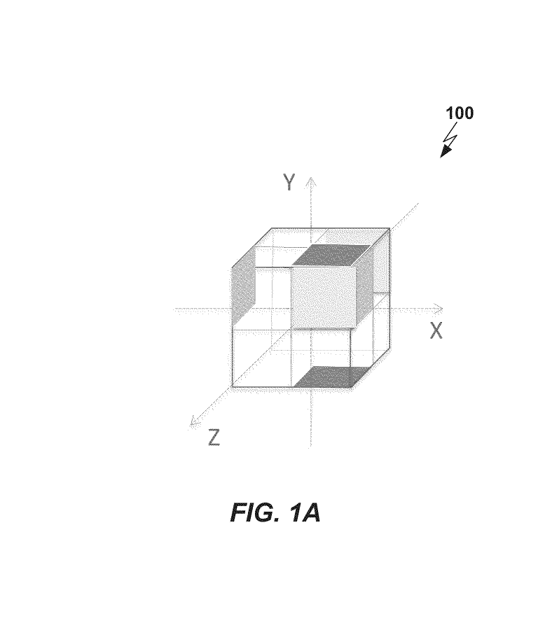

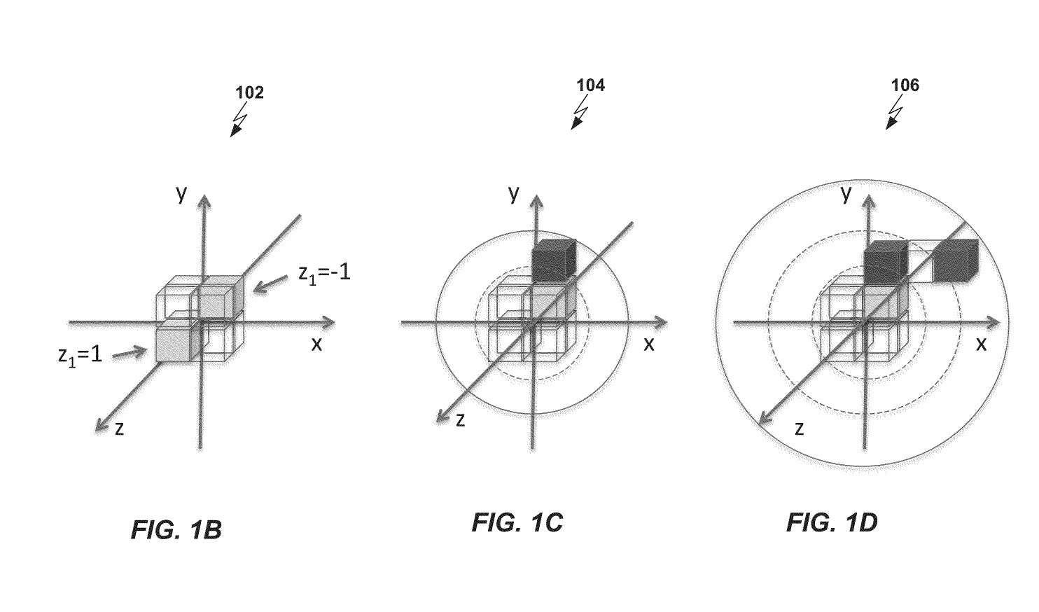

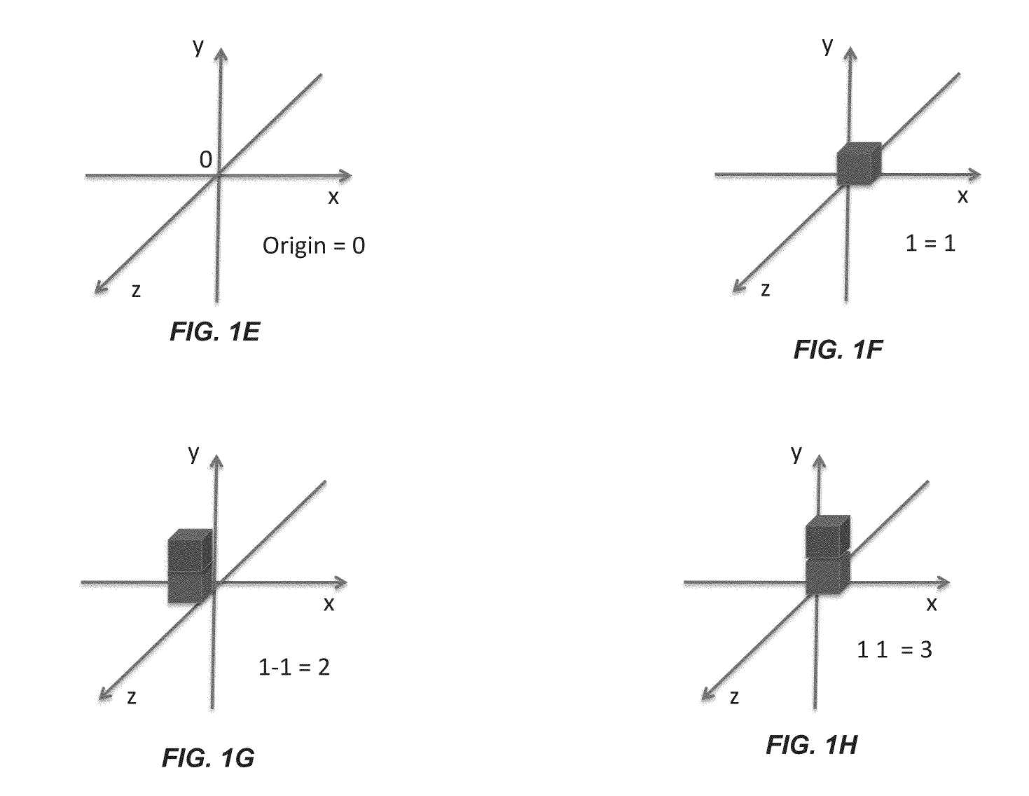

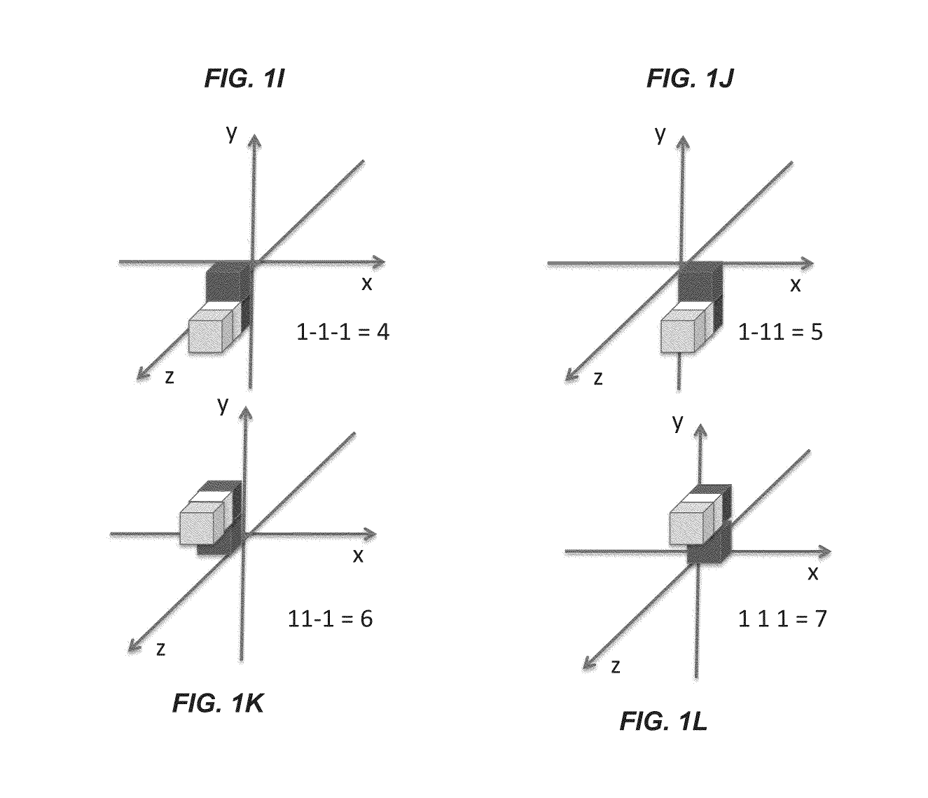

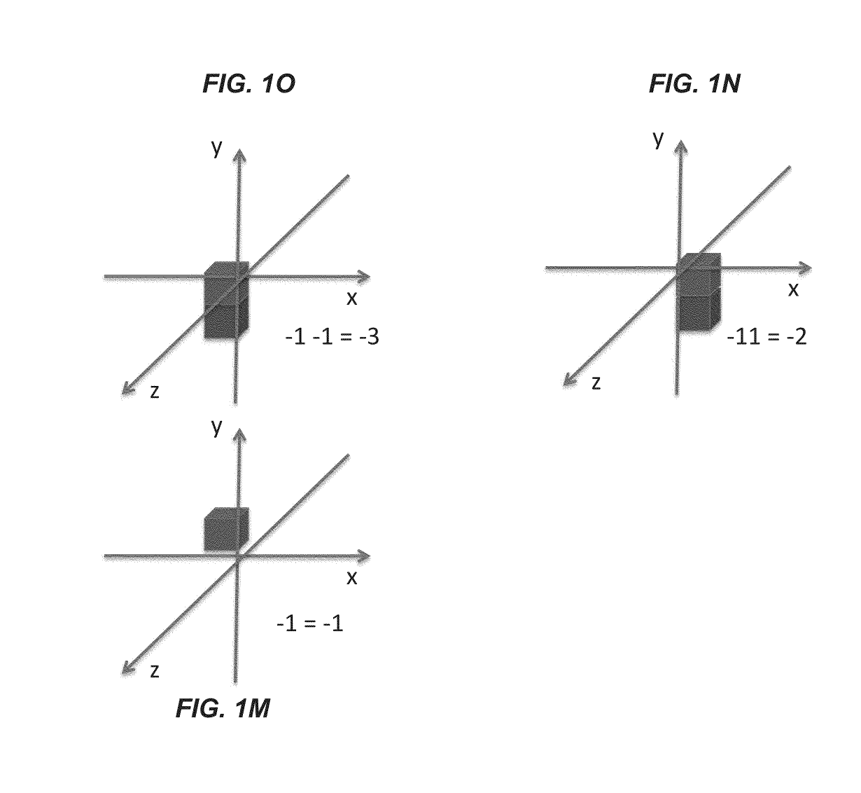

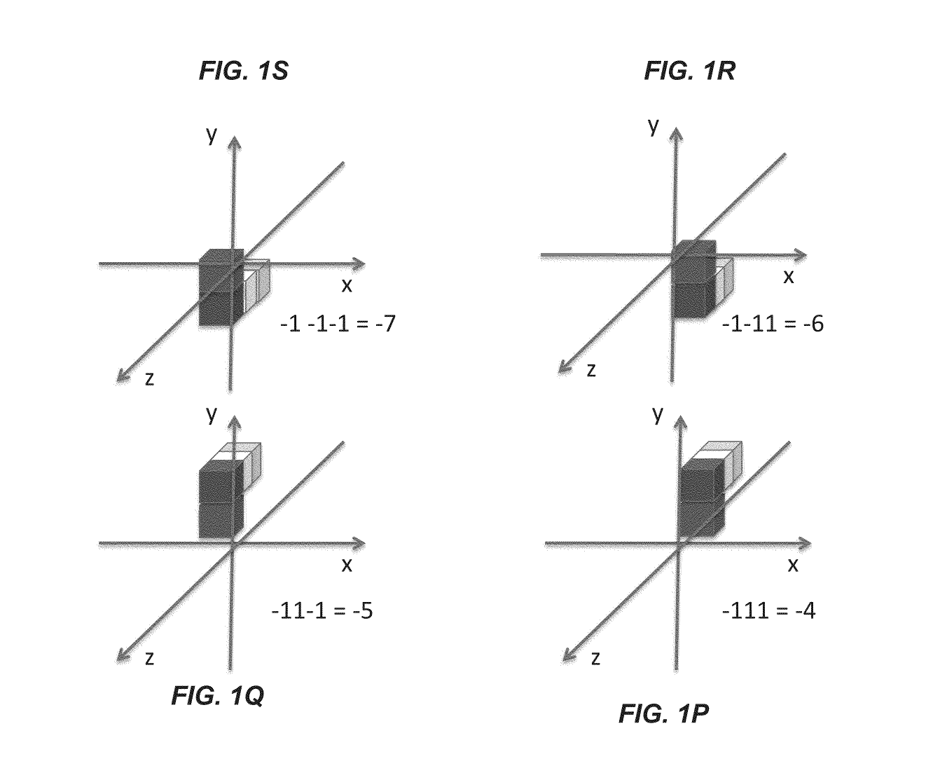

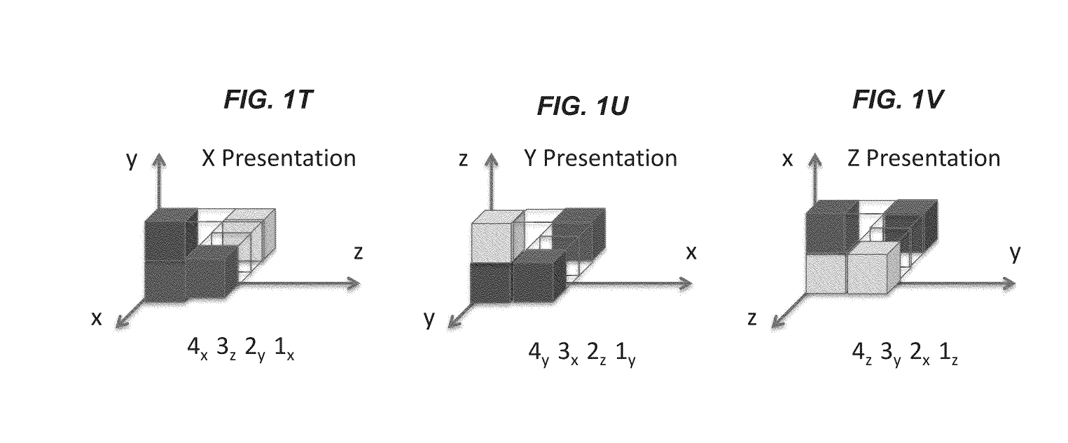

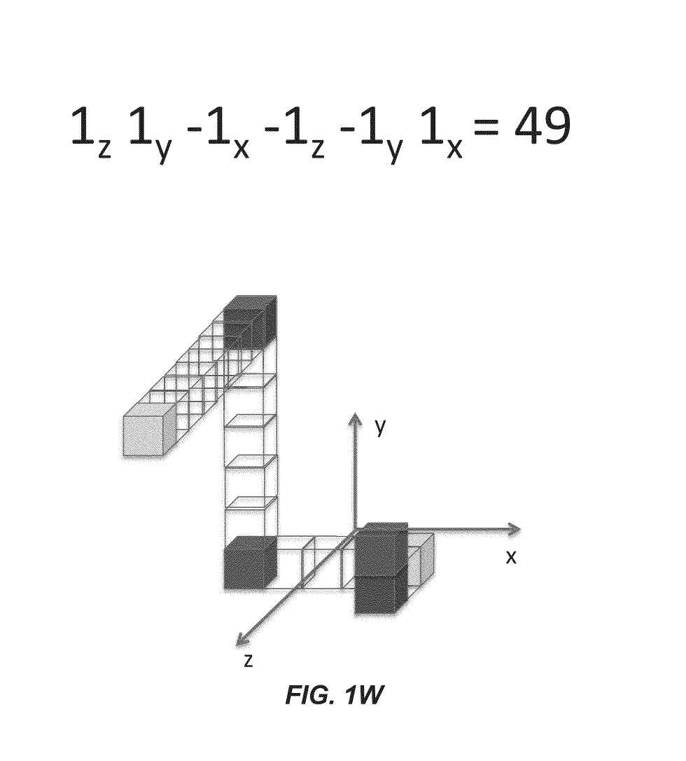

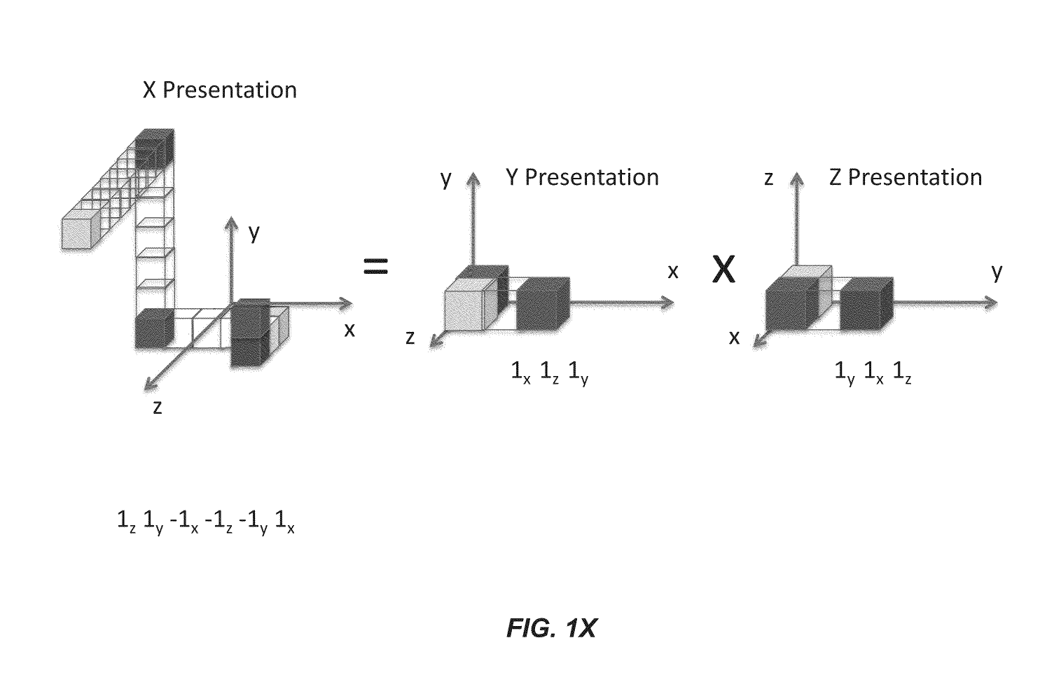

A binary number that has been mapped to three dimensions in the manner disclosed herein may be represented as a sequence of relations in a three-dimensional space. For example, referring to FIG. 1A, a three-dimensional space 100 is shown having three dimensions representing orthogonal axes in a three-dimensional space. In particular, the x dimension may represent an x axis in the three-dimensional space 100, the y dimension may represent a y axis in the three-dimensional space 100, and the z dimension may represent a z axis in the three-dimensional space 100, where the x, y, and z axes are orthogonal to each other.

FIG. 1A shows a cube consisting of eight points in the three-dimensional space, namely the points {−1, −1, −1}, (−1, −1, +1), (−1, +1, −1), (−1, +1, +1), (+1, −1, −1), (+1, −1, +1), (+1, +1, −1), and (+1, +1, +1). These eight points represent the “core” layer. The shaded cube in FIG. 1A is located at coordinates (+1, +1, +1) in the three-dimensional space 100.

According to embodiments of the present invention, the three-dimensional space 100 may have a layered coordinate system, and each number may be represented as a collection of points in the three-dimensional space 100. Each number may include one or more layers within the coordinate system of the three-dimensional space 100. For any particular number, each layer corresponds to a particular bit position within the number, and each number is read from the outside layer to the inside layer. Each number is represented as a combination of bits (which, as stated above, may have a value of +1 or −1). The bits of each number are ordered within the three dimensions of the three-dimensional space 100. The values of +1 and −1 represent opposite directions in the three-dimensional space 100.

FIGS. 1B, 1C, and 1D illustrate layered relations between the coordinates. To illustrate the layers, consider the decimal number six, which may be represented as the binary number +1+1−1. If we assume the three dimensions the order of z, y, x, then this number may be mapped to the three dimensions as follows: +1x+1y₂−1z₁. The first, “core” layer 102 shown in FIG. 1B contains the same set of eight three-dimensional points as shown in FIG. 1A. The first bit (−1z₁) is illustrated in FIG. 1B by a point having a z coordinate at z=−1. This is the first layer of the binary number +1+1−1.

FIG. 1C illustrates the second layer 104, which extends along the direction of the y axis. The second bit (+1y₂) in the binary number +1+1−1 is illustrated in FIG. 1C by a point having a y coordinate at y=2, namely the point in FIG. 1C at (1, 2, −1). Note that this point was not present in the first layer 102 of FIG. 1A, but was added to the first layer 102 of FIG. 1B to produce the second layer 104 of FIG. 1C. As illustrated by this example, in which the second layer 104 contains the entirety of the previous (first) layer 102 plus one or more additional points extending along the y axis, each new layer contains the entirety of the previous layer plus one or more additional points extending along the axis corresponding to the new layer.

FIG. 1D illustrates the third layer 106, which extends along the direction of the x axis. The third bit (+1x₃) in the binary number +1+1−1 is illustrated in FIG. 1D by a point having an x coordinate at x=3, namely the point in FIG. 1D at (3, 2, −1), which was not present in the second layer 104 of FIG. 1C, and which was added to the second layer 104 of FIG. 1C to produce the third layer 106 of FIG. 1D. (The unfilled point at (2, 2, −1) represents a coordinate relation between the point at (3, 2, −1) in the third layer and the point at (1, 2, −1) in the second layer.)

Embodiments of the present invention may be used to represent numbers according to layers such as those shown in FIGS. 1B-1D. To understand how to represent numbers according to the layers of FIGS. 1B-1D, consider FIGS. 1E-1H. First, consider the origin point at (0, 0, 0), illustrated in FIG. 1E. This point represents the number zero.

Now consider the binary number 1. To construct a three-dimensional representation of this number, assume that the order of the dimensions is x, y, z. The three-dimensional representation of the binary number 1 is constructed by reading each bit in the number and creating a point in three-dimensional space corresponding to that bit, to create a set of three-dimensional points corresponding to the number. Because the binary number 1 only contains 1 bit, the corresponding representation of the binary number 1 in three-dimensional space consists of exactly one point in three-dimensional space, namely a single point corresponding to the bit 1.

More specifically, the number to be represented in three-dimensional space is read one bit at a time, starting with the lowest bit on the right and moving toward the highest bit on the left in sequence to the next highest bit until the highest bit in the number is reached. A corresponding point in three dimensional space is created for each such bit.

Recall that the three dimensions are assigned a particular order. Assume for purposes of example that the dimensions are assigned an order of x, y, z. Therefore, the first (lowest) bit in a number is associated with the x dimension, the second (next-lowest) bit in the number is associated with the y dimension, the third (next-lowest) bit in any number is associated with the z dimension, the fourth (next-lowest) bit in any number is associated with the x dimension, and so on. In other words, the bits in the number are assigned to the x, y, and z dimensions in a repeating pattern (in whatever order has been assigned to the x, y, and z dimensions), starting with the lowest bit of the number and continuing bit-by-bit until the highest bit of the number is reached.

Each dimension is associated with a corresponding number, starting with 1, and increasing incrementally, in a repeating pattern of dimensions. For example, if the dimensions are assigned the order x, y, z, then the number 1 may be associated with the x dimension 1, the number 2 may be associated with the dimension y, the number 3 may be associated with the dimension z, the number 4 may be assigned to the dimension x, and so on. As this example illustrates, each dimension may be associated with more than one number, depending on the corresponding bit position. Each bit position may be designated with a subscript after the corresponding dimension, such as x₁, y₂, z₃, x₄, y₅, z₆, etc. The assignment of bits in a binary number may be designated by writing each bit followed by its associated dimension. For example, the binary number +1−1+1+1+1−1 may be written as +1x₁₋₁y₂+1z₃+1x₄+1y₅−1z₆.

Techniques that may be used to represent binary numbers in three-dimensional space according to embodiments of the present invention will now be described. First consider the decimal number 1, which is equal to the binary number 1. The lowest bit of this number is assigned to the first dimension in the assigned order of dimensions. In this case, the lowest bit is equal to 1, and the first dimension is the x dimension. Therefore the value of 1 is assigned to the x dimension. As described above, this may be written as +1x₁.

A point representing +1x₁ may then be created in three-dimensional space to represent the first bit of the binary number 1. A point representing +1x₁ (which may alternatively be written as x1) may be created by starting at the origin point and moving along the axis indicated by +1x₁ (namely, the x axis), in the direction indicated by +1x₁ (namely, in the positive direction), to the coordinate on the x axis indicated by the subscript of +1x₁ (namely, to the coordinate x=0). This results in the creation of a point at x1=1, y1=1, z1=1. This single point represents the binary number 1. Note that coordinates of x=0, y=0, and z=0 are only used to represent the number 0, namely by the origin at (0, 0, 0). No other number is represented by a point having any coordinate equal to zero.

Now consider the decimal number 2, which is equal to the conventional binary number 10 and to the binary number +1−1 according to certain embodiments of the present invention. These two bits, starting with the lowest bit and moving bit-by-bit to the highest bit, may be assigned to the x and y dimensions, respectively. For example, the binary number +1−1 may be assigned to the x and y dimensions to produce a mapping of the binary number +1−1 to the representation +1y₂−1x₁.

Based on this assignment of bits to dimensions, and as shown in FIG. 1G, the binary number +1−1 may be represented in three-dimensional space by a collection of points, each of which corresponds to a corresponding bit in the binary number +1−1. In particular, because the binary number +1−1 contains exactly two bits, the binary number +1−1 is represented by exactly two points in three-dimensional space in FIG. 1G. More specifically, reading from the lowest bit to the highest bit:
the lowest bit in +1y₂₋₁x₁ (i.e., the rightmost bit, having a value of −1x₁), is represented by a point at x=−1, y=1, z=1;
the next-lowest bit in +1y₂₋₁x₁ (i.e., the leftmost bit, having a value of +1y₂), is represented by a point at x=−1, y=2, z=1, as the result of moving from the previous point (x=−1, y=1, z=1) in the positive direction on the y axis to the coordinate y=2.

The resulting three-dimensional representation of decimal 2 is, as shown in FIG. 1G, a set of exactly two points at coordinates (x=−1, y=1, z=1) and (x=−1, y=2, z=1). Note that in the case of a one-bit or two-bit number, the z coordinates (or more generally, the coordinates of the third dimension in the ordered sequence of dimensions) may be chosen arbitrarily because the z (third) coordinate is not necessary to represent the number.

Now consider the decimal number 3, which is equal to the conventional binary number 11 and to the binary number +1+1 according to certain embodiments of the present invention. These two bits, starting with the lowest bit and moving bit-by-bit to the highest bit, may be assigned to the x, y, and z dimensions. As a result, the binary number +1+1 may be assigned to the x, y, and z dimensions to produce +1y₂₊₁x₁.

Based on this assignment of bits to dimensions, and as shown in FIG. 1H, the binary number +1+1 may be represented in three-dimensional space by a collection of points, each of which corresponds to a corresponding bit in the binary number +1+1. In particular, because the binary number +1+1 contains exactly two bits, the binary number +1+1 is represented by exactly two points in three-dimensional space in FIG. 1H. More specifically, reading from the lowest bit to the highest bit:
the lowest bit in +1y₂+1x₁ (i.e., the rightmost bit, having a value of +1x₁), is represented by a point at x=1, y=1, z=1;
the next-lowest bit in +1y₂+1x₁ (i.e., the leftmost bit, having a value of +1y₂), is represented by a point at x=1, y=2, z=1, as the result of moving from the previous point (x=1, y=1, z=1) in the positive direction on the y axis to the coordinate y=2.

The resulting three-dimensional representation of decimal 3 is, as shown in FIG. 1H, a set of exactly two points at coordinates (x=+1, y=1, z=1) and (x=1, y=2, z=1).

Further examples of three-dimensional representations of the decimal numbers 4, 5, 6, and 7 are shown in FIGS. 1I-1L, respectively. Those three-dimensional representations may be created in the same way as those described above. Similarly, FIGS. 1M-1S show representations of the decimal numbers −1, −2, −3, −4, −5, −6, and −7, respectively. Those three-dimensional representations may be created in the same way as those described above.

The particular examples of numbers and their representations shown herein are merely examples and do not constitute limitations of the present invention. Those having ordinary skill in the art will understand how to use the techniques disclosed herein to represent other numbers using three-dimensional relations and in three-dimensional space. Similarly, the particular examples of multiplications shown herein are merely examples and do not constitute limitations of the present invention. Those having ordinary skill in the art will understand how to use the techniques disclosed herein to perform multiplication of other numbers and to represent the results of such multiplications using three-dimensional relations and in three-dimensional space.

Once a particular order for the x, y, and z dimensions has been chosen to represent numbers (e.g., xyz or xzy), any particular number may be represented in any of three equivalent ways as points in three-dimensional space. For example, if the sequence xyz is chosen, then a number may be represented by mapping its bits to xyz coordinates in any of the following three sequences: xyz, yzx, or zxy. This is illustrated by the examples in FIGS. 1T, 1U, and 1V, which illustrate alternative representations of the binary number 1111 (decimal 15). FIG. 1T shows a first three-dimensional representation of the number 15 (i.e., binary 1111), in which the number 15 has been mapped to the x, y, and z dimensions in the order x, y, z. As a result, bit position 1 has been mapped to the x dimension, bit position 2 has been mapped to the y dimension, bit position 3 has been mapped to the z dimension, and bit position 4 has been mapped to the x dimension. In FIG. 1T, points corresponding to bits mapped to the x dimension are displayed in red, points corresponding to bits mapped to the y dimension are displayed in green, and points corresponding to bits mapped to the z axis are displayed in yellow. These particular colors are used merely for ease of illustration.

The three-dimensional representation 102 of the number 15 in FIG. 1T includes a red point at coordinates x=1, y=1, z=1 (representing the lowest (rightmost) bit in binary 1111), a green point at coordinates x=1, y=2, z=1 (representing the second lowest bit in binary 1111), a yellow point at coordinates x=1, y=2, z=3 (representing the next highest bit in binary 1111), and a red point at coordinates x=4, y=2, z=3, representing the highest (leftmost) bit in binary 1111.

An alternative representation of the number 15 is shown in FIG. 1U, in which the dimensions have been ordered in the order y, z, x, so that the y dimension has been mapped to bit position 1, the z dimension has been mapped to bit position 2, the x dimension has been mapped to bit position 3, and the y dimension has been mapped to bit position 4. Therefore, the three-dimensional representation of the number 15 in FIG. 1U includes a green point at coordinates x=1, y=1, z=1 (representing the lowest (rightmost) bit in binary 1111), a yellow point at coordinates x=1, y=1, z=2 (representing the second lowest bit in binary 1111), a red point at coordinates x=3, y=1, z=2 (representing the next highest bit in binary 1111), and a green point at coordinates x=3, y=4, z=2, representing the highest (leftmost) bit in binary 1111.

A third representation of the number 15 is shown in FIG. 1V, in which the dimensions have been ordered in the order z, x, y, so that the z dimension has been mapped to bit position 1, the x dimension has been mapped to bit position 2, the y dimension has been mapped to bit position 3, and the z dimension has been mapped to bit position 4. Therefore, the three-dimensional representation of the number 15 in FIG. 1V includes a yellow point at coordinates x=1, y=1, z=1 (representing the lowest (rightmost) bit in binary 1111), a red point at coordinates x=2, y=1, z=1 (representing the second lowest bit in binary 1111), a green point at coordinates x=2, y=3, z=1 (representing the next highest bit in binary 1111), and a yellow point at coordinates x=2, y=3, z=4, representing the highest (leftmost) bit in binary 1111

Once one or more numbers have been mapped to three dimensions and/or represented in three-dimensional space, mathematical operations (e.g., arithmetic operations, such as multiplication, division, addition, and subtraction) may be performed on one or more of such numbers to produce numbers which themselves may be mapped to three dimensions and/or represented in three-dimensional space. As merely one example, FIG. 1W shows an example of a three-dimensional representation of the decimal number forty-nine (49), which is equal to the binary number 110001 or +1+1−1−1−1+1. In the example of FIG. 1W, the order of dimensions is x, y, z. Therefore, the binary number +1+1−1−1−1+1 can be mapped to the x, y, and z dimensions as follows: +1z+1y₅−1x₄−1z₃−1y₂+1x₁. As can be seen from FIG. 1W, reading from right to left in this mapping:
the bit +1x₁ is represented by a point at x=1, y=1, z=1;
the bit −1y₂ is represented by a point at x=1, y=−2, z=1;
the bit −1z₃ is represented by a point at x=1, y=−2, z=−3;
the bit −1x₄ is represented by a point at x=−4, y=−2, z=−3;
the bit +1y₅ is represented by a point at x=−4, y=5, z=−3; and
the bit +1z₆ is represented by a point at x=−4, y=5, z=6.

The decimal number 49 may be factored into the two factors (multiplicands) decimal 7 and decimal 7. This is illustrated in FIG. 1X, which shows that the mapped binary number +1z₆+1y₅−1x₄−1z₃−1y₂+1x₁ (which is represented in an x presentation, in which the dimensions are ordered x, y, z) may be factored into the mapped binary number +1x₂+1z₂+1y₁ (which is represented in a y presentation, in which the dimensions are ordered y, z, x) and the mapped binary number +1y₃+1x₂+1z₁ (which is represented in a z presentation, in which the dimensions are ordered y, x, z). Techniques will be described below for both performing such factorization of a number based on the number's three-dimensional representation, and for performing the inverse of factorization, namely multiplication of two numbers based on their three-dimensional representations.

Note that when a number in one presentation is factored into two multiplicands, the two multiplicands are presented in the remaining two presentations. For example, if a number represented in the x presentation is factored into two multiplicands, then the two multiplicands are represented in the y and z presentations. As another example, if a number represented in the y presentation is factored into two multiplicands, then the two multiplicands are represented in the z and x presentations. As yet another example, if a number represented in the z presentation is factored into two multiplicands, then the two multiplicands are represented in the x and y presentations.

Another aspect of the present invention is directed to a method that processes the bits in a binary number that are equal to 0 (or −1) as complements of the binary value of 1. This aspect of the present invention is explained by the fact that, for each position in a binary number, if that position is not occupied by the value of 1 then it is occupied by the value of 0 (or −1), and if that position is not occupied by the value of 0 (or −1) then it is occupied by the value of 1.

A further aspect of the present invention is directed to a method that represents a number by two properties: (1) the sequence order of a space relation, such as the sequence order (x, y), (y, z), (z, x), or the sequence order (z, y), (y, x), (x, z); and (2) the digit relation between 0 (or −1) and 1.

Yet another aspect of the present invention is directed to a factorization method that uses the space relation and the digit relation of a product of two multiplicands to reproduce the two multiplicands. This process of factorization is the inverse process of multiplication.

In particular, this factorization method is a recursive method that replaces the highest space relation and the highest digit relation first, and lower space relations and digit relations later, step by step until finishing the process of factorization. More specifically, the recursive method begins with the highest space relation and the highest digit relation, then proceeds to the next-highest space relation and digit relation, and then to the next-highest space relation and digit relation, and so on, until all of the space relations and digit relations have been replaced to produce the factorization (i.e., multiplicands) of the product.

Embodiments of the present invention may use a reversible method to perform both multiplication and factorization (which is the inverse of multiplication) in quadratic computation time.

A “whole 1 number,” denoted by 1ₙ, is a binary number containing exactly and solely n 1's. For example, 1₃=111. Similarly, a “whole 0 number,” denoted by 0ₙ, is a binary number containing exactly and solely n 0's. For example, 0₄=0000. As described above, however, embodiments of the present invention may represent binary numbers using +1s and −1s. Therefore, a “whole −1 number,” denoted by −1ₙ, is a binary number containing exactly and solely n−1's. For example, −1₄=−1−1−1−1.

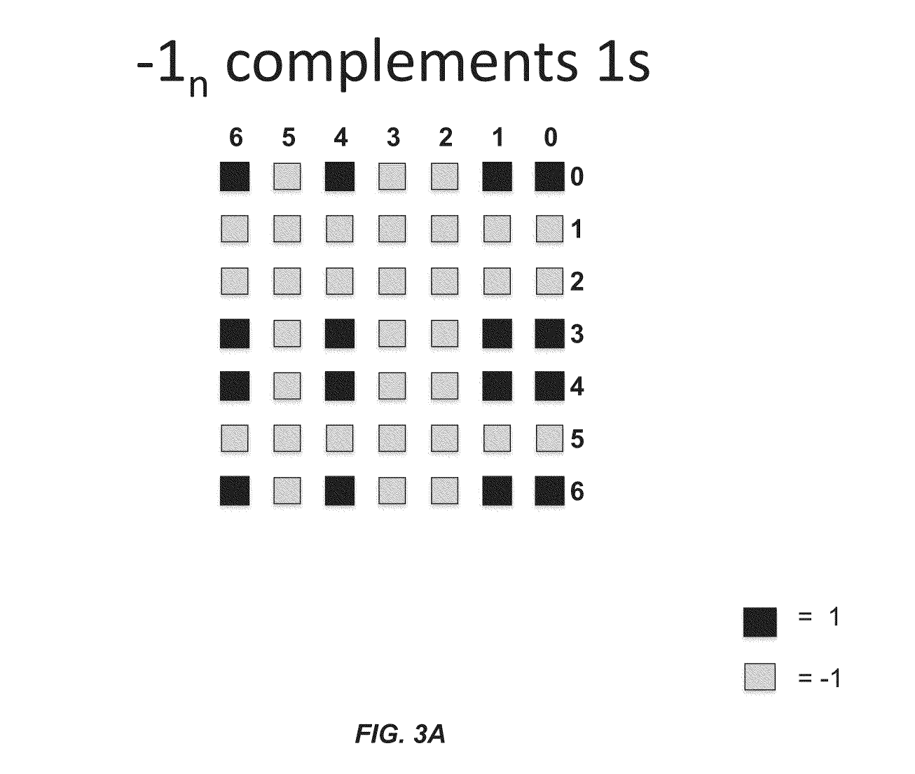

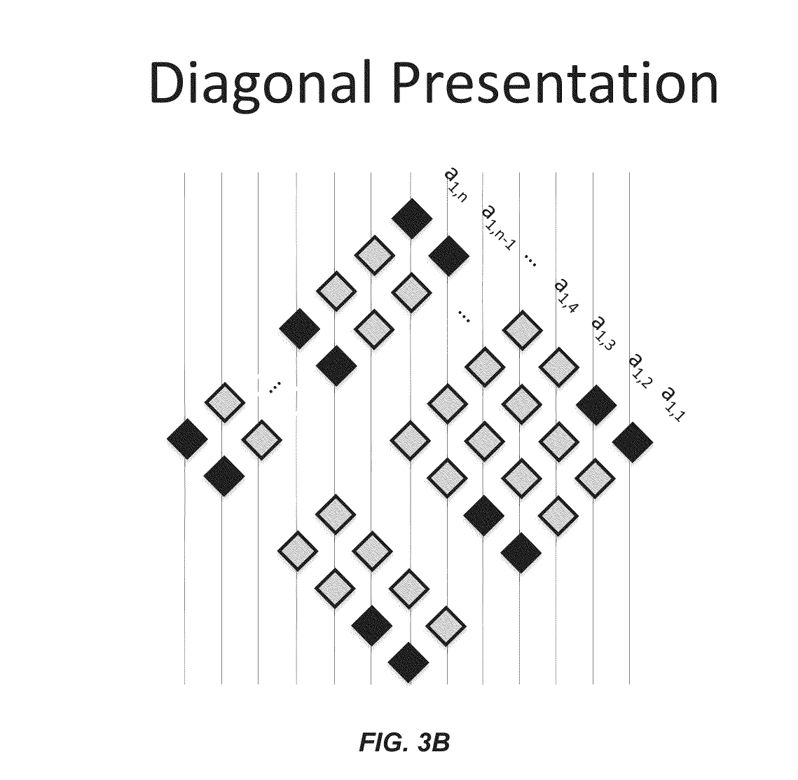

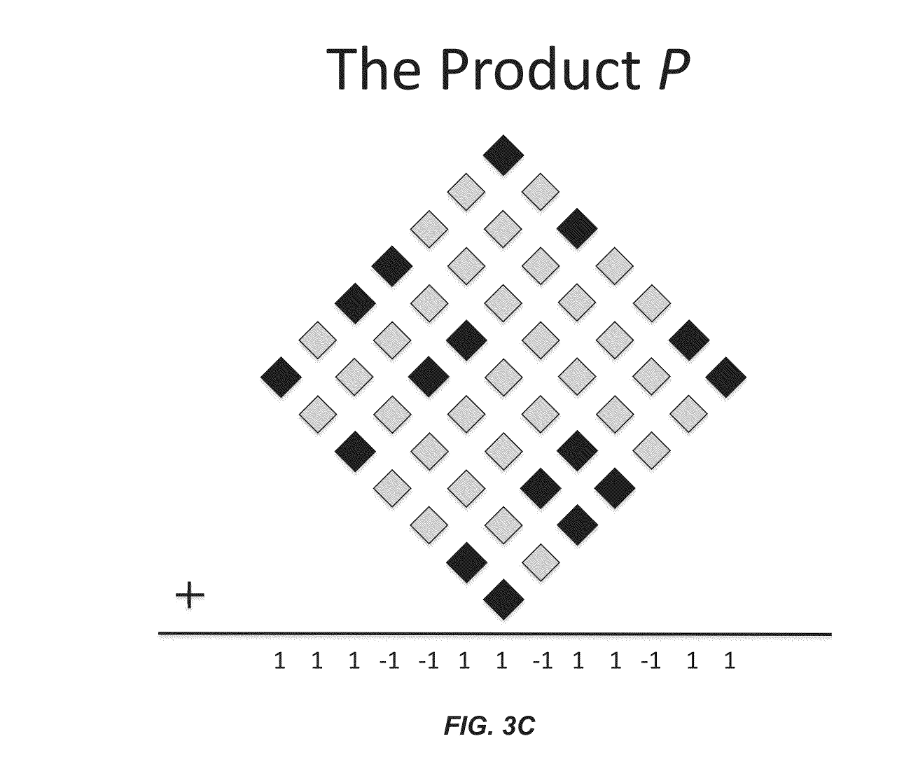

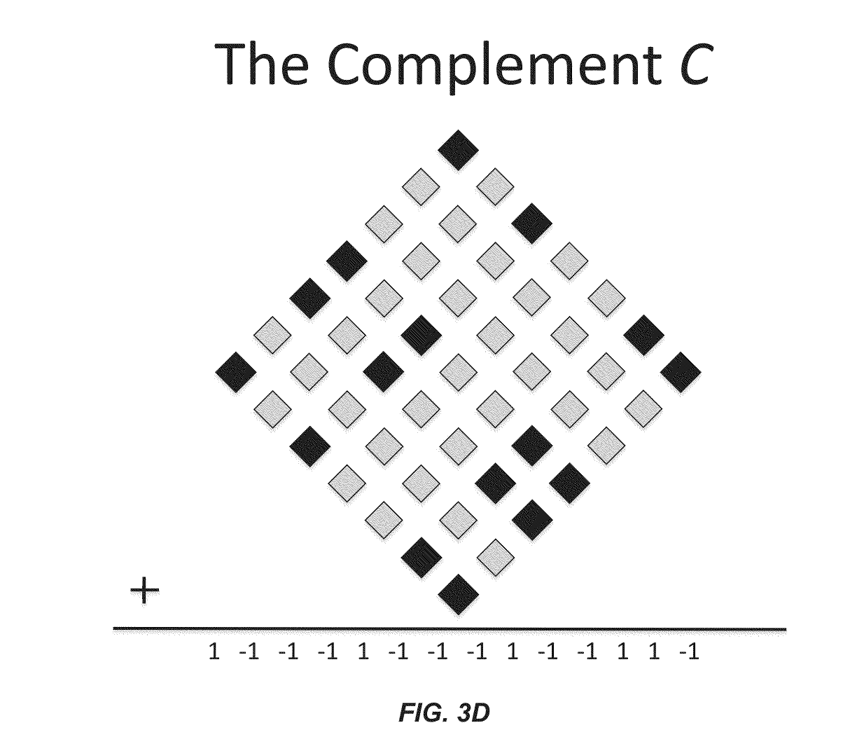

Referring to FIG. 3A, a set of partial products resulting from multiplying a number a (1010011) by a number b (1011001) is shown in a square form. In FIG. 3A, each 1 bit is represented by a white square, and each −1 bit is represented by a black square. In FIG. 3A, each column contains either the number b or a −1ₙ number. The columnar −1ₙ numbers in columns 2, 3, and 5 separate the is in the number a from each other. Therefore, we say that the number a is “separated by” the −1ₙ numbers in columns 2, 3, and 5. Note that this use of the term “separated by” does not refer to arithmetic division or any other arithmetic operation, but instead to separation of is from each other by −1s.

Similarly, in FIG. 3A, each row contains either the number a or a −1ₙ number. The −1ₙ numbers in rows 1, 2, and 5 separate the is in the number b from each other. Therefore, we say that the number b is “separated by” the −1ₙ numbers in rows 1, 2, and 5. Note that this use of the term “separated by” does not refer to arithmetic division or any other arithmetic operation, but instead to separation of is from each other by −1s.

We now refer to the “difference” D of the numbers a and b. The difference D is the union of the whole −1 numbers which separates number a (i.e., the whole −1 numbers in columns 2, 3, and 5) and the whole −1 numbers which separate number b (i.e., the whole −1 numbers in rows 1, 2, and 5).

As shown in FIG. 3B, the partial products of FIG. 3A may alternatively be represented in a “diagonal form.” The diagonal form of the partial products is produced by rotating the square form of FIG. 3A by forty-five degrees clockwise. The resulting diagonal form shown in FIG. 3B contains thirteen columns, illustrated by vertical lines in FIG. 3B.

As shown in FIG. 3C, the product P of numbers a and b may be obtained by summing the bits in each of the thirteen columns (and carrying bits to the next successive column as necessary). As shown in FIG. 3C, the product P of numbers a and b is +1+1+1−1−1+1+1−1+1+1−1+1+1 (alternatively, 1110011011011).

If the product P is known, and B is the number of bits in P, then the complement C of P may be found using the following equation: C=1ₙ²−P, where n=B/2 if B is even and where n=(B+1)/2 if B is odd. For example, if the product P=1110011011011 (as in the example of FIG. 3C), then B=13, in which case n=7 (i.e., (13+1)/2), 1ₙ²=11111100000001, and C=1ₙ²−P=11111100000001−1110011011011=10001000100110. (What is B?)

As shown in FIG. 3D, the complement C may also be obtained by summing all of the −1s in the diagonal form of the partial products. As shown in FIG. 3D, the resulting complement +1−1−1−1+1−1−1−1+1−1−1+1+1−1 is the same as is obtained by the equation C=1ₙ²−P.

Embodiments of the present invention may factor a number (product) P number as follows. To factor P, a complement C (as that term is used above) of P must first be found. Embodiments of the present invention may find the complement C by, for example, using the equation C=1ₙ²−P.

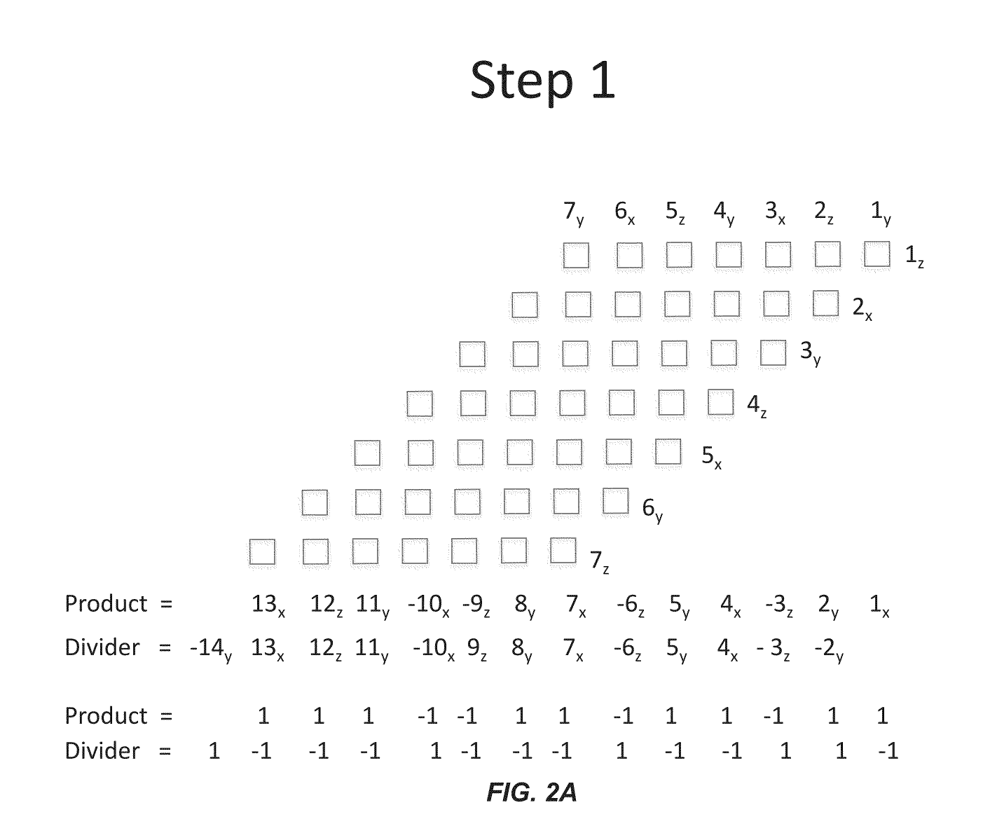

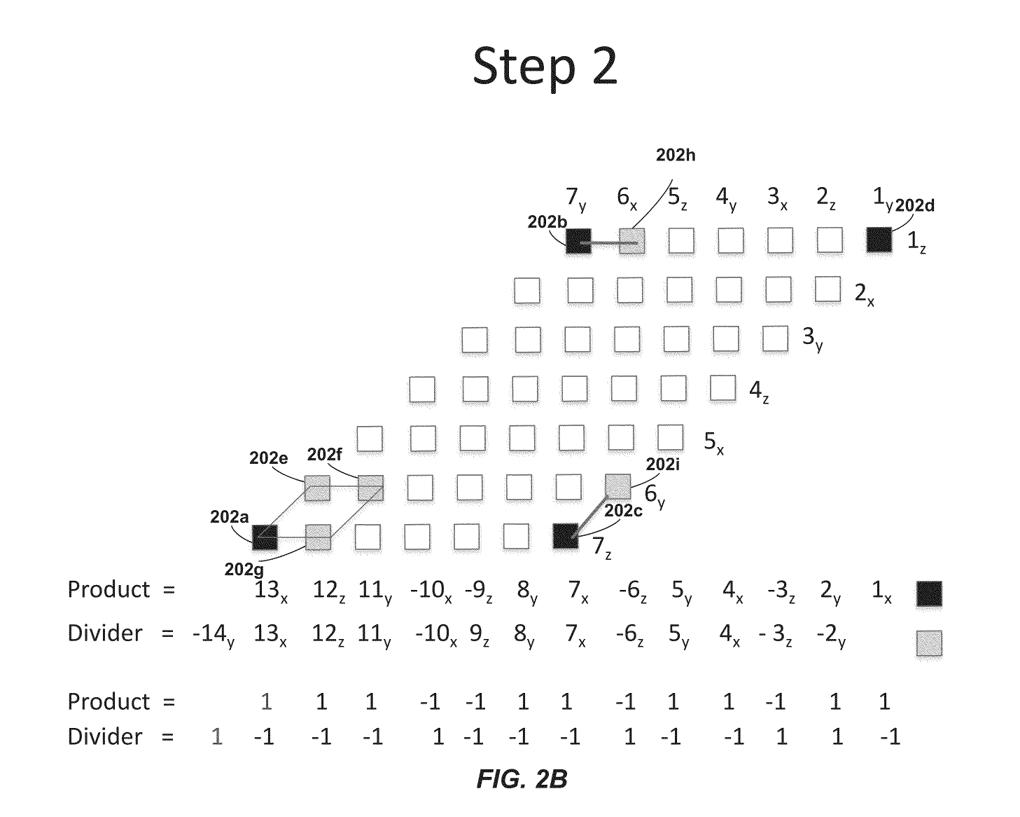

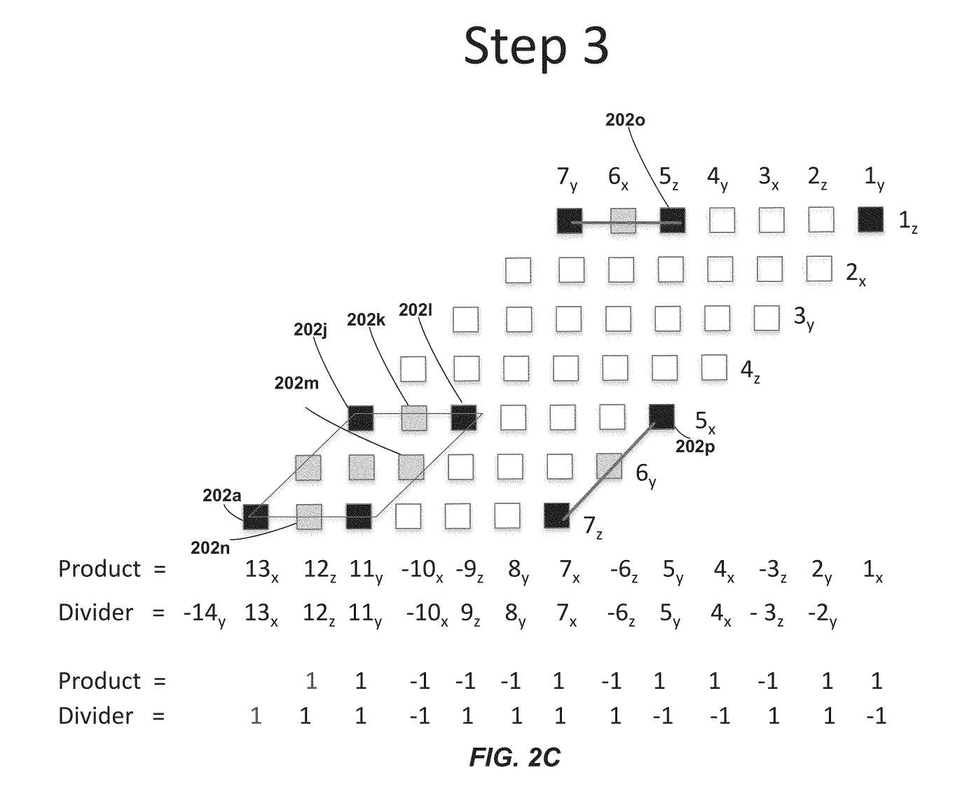

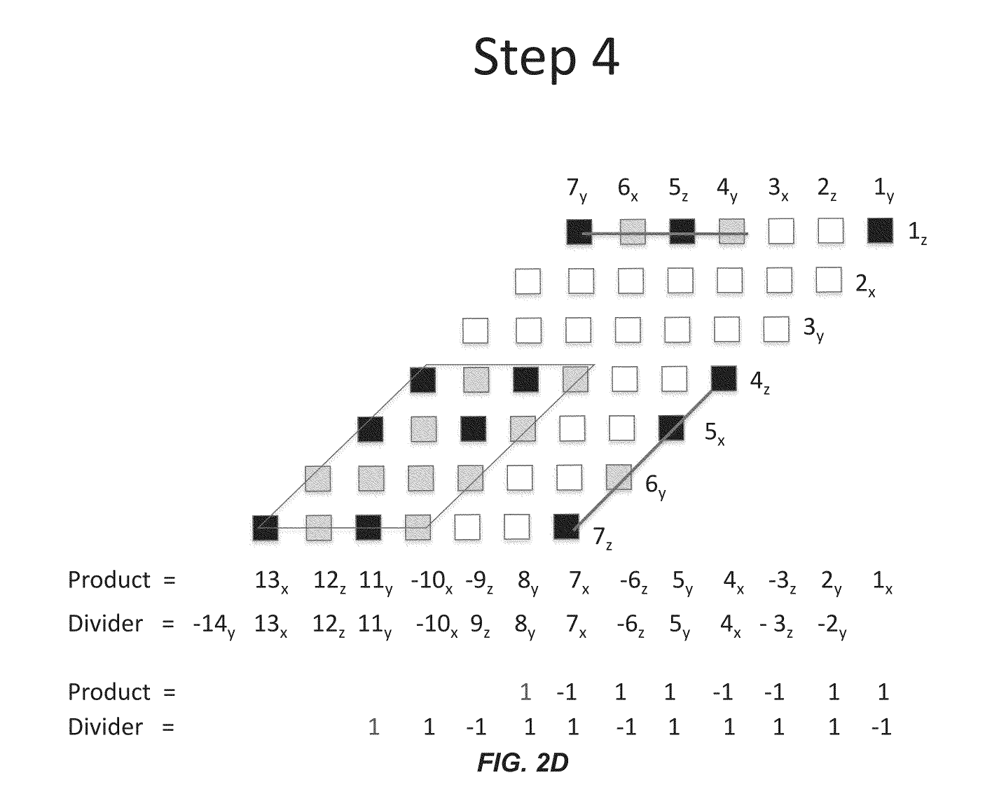

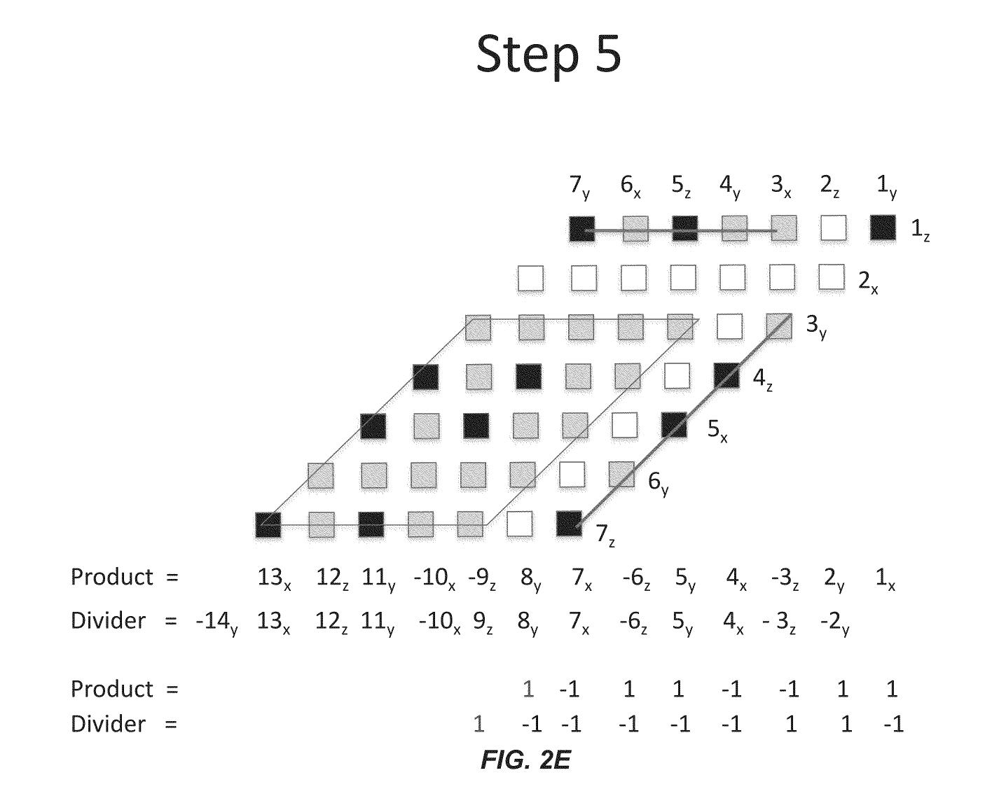

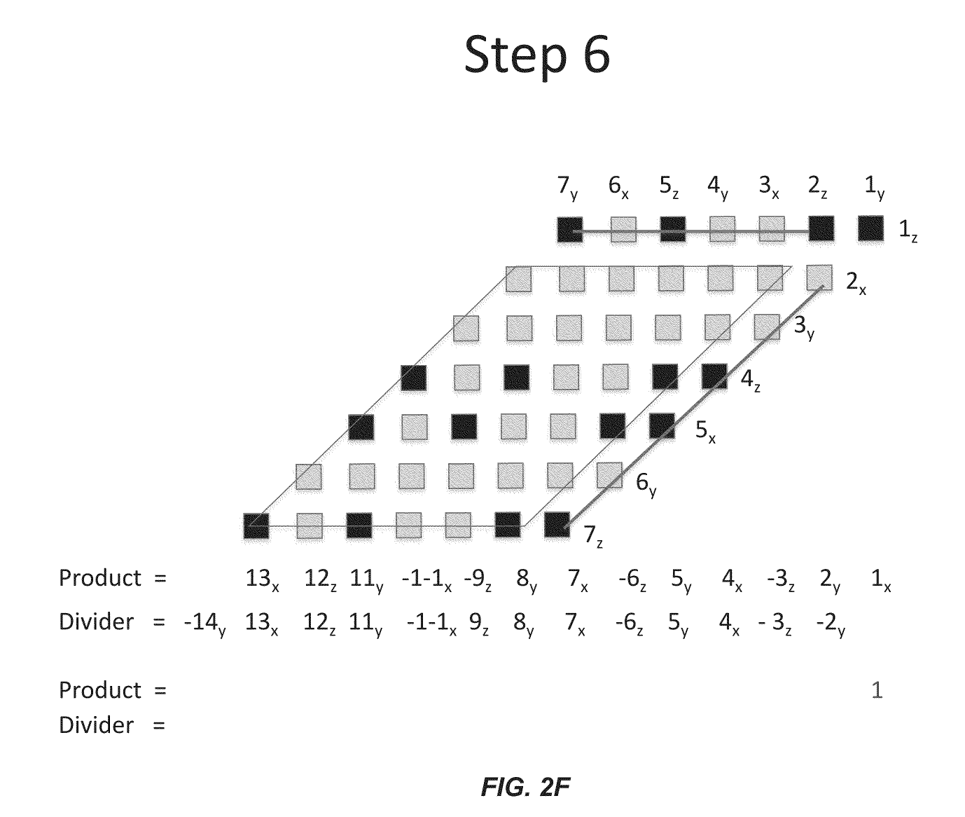

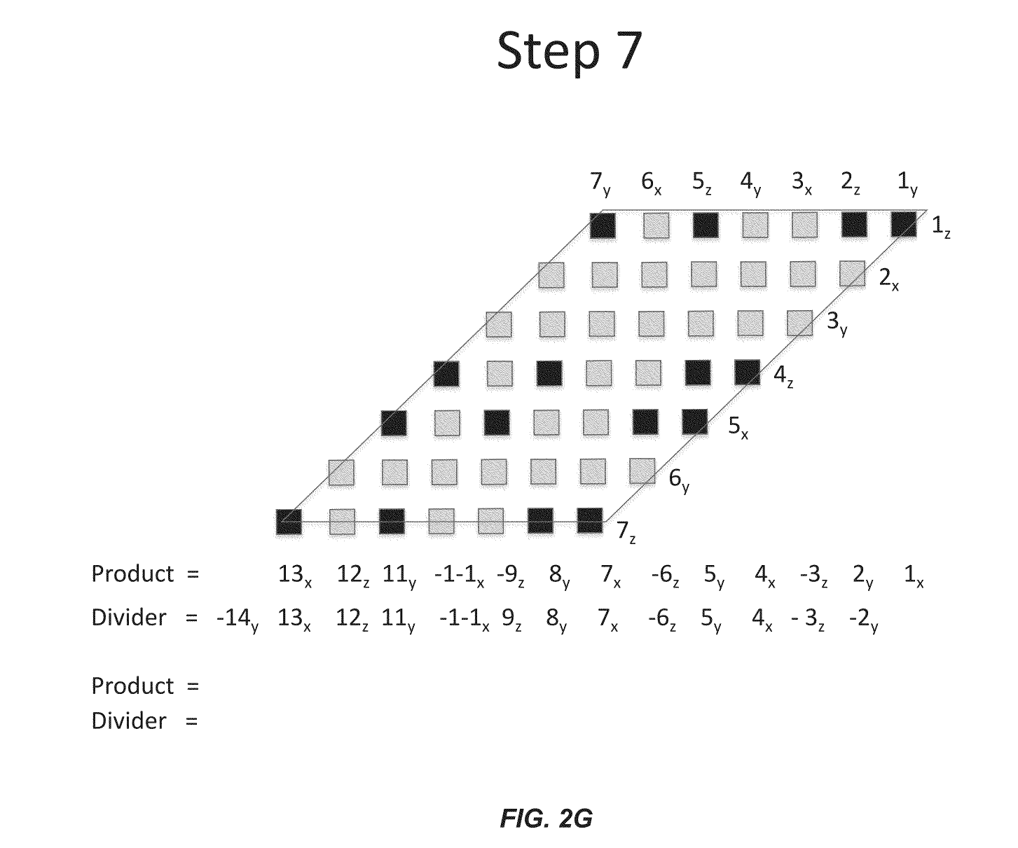

Once the complement C of the product P is found, the product P and the complement C may be used to factor P. An illustration of steps that may be performed to factor P is shown in FIGS. 2A-2G.

First, an order for the three dimensions x, y, and z is selected. As mentioned above, any order may be selected. Assume for purposes of example that the order (x, y, z) is selected. The bits of the product P may be assigned to the dimensions x, y, and z in the selected order, starting with the lowest-order bit of the product P. For example, as shown in FIG. 2A, the product P may be assigned to the dimensions x, y, and z in the order (x, y, z), starting with the lowest-order bit of the product P as follows: 13x12z11y−10x−9z8y7x−6z5y4x−3z2y1x (where a negative sign before a bit indicates that the value of the bit is zero, and where the absence of a negative sign before a bit indicates that the value of the bit is one).

Similarly, the bits of the complement C may be assigned to the dimensions x, y, and z in the selected order, starting with the lowest-order bit of the complement C. For example, as shown in FIG. 2A, the complement C may be assigned to the dimensions x, y, and z in the order (x, y, z), starting with the lowest-order bit of the complement C as follows: −14y13x12z11y−10x9z8y7x−6z5y4x−3z−2y1x (where a negative sign before a bit indicates that the value of the bit is one, and where the absence of a negative sign before a bit indicates that the value of the bit is zero). The bit 1x of the divider D is omitted from FIG. 2A because it is not needed to perform the factorization of the product P.

A diamond structure to hold the partial products is then constructed. Recall that B is the number of bits in the product P, and that n=B/2 if B is even and that n=(B+1)/2 if B is odd (i.e., if the highest-order bit having a value of 1 in the product P is at an odd bit position). Therefore, the number of bits in each of the multiplicands is equal to n. Therefore, a diamond structure may be constructed having n rows and n columns. An example of such a diamond structure is shown in FIG. 2A. Note that the inside of each cell (square) in this diamond structure is shown as white to indicate that the contents of these cells have not yet been assigned any values. As will be shown in FIGS. 2B-2G, cells having a value of 1 will be illustrated in black, while cells having a value of 0 will be illustrated in gray.

The rows and columns of the diamond structure may be assigned to dimensions. For example, the columns may be assigned to the dimensions x, y, and z from right to left in the previously-selected order, starting with the second dimension. For example, assuming that the selected order of the dimensions is (x, y, z), then the second dimension is y. As shown in FIG. 2A, the columns are assigned to dimensions in the order (x, y, z), starting with dimension y, as follows: 1y2z3x4y5z6x7y.

The rows may be assigned to the dimensions x, y, and z from top to bottom in the previously-selected order, starting with the third dimension. For example, assuming that the selected order of the dimensions is (x, y, z), then the third dimension is z. As shown in FIG. 2A, the rows are assigned to dimensions in the order (x, y, z), starting with dimension z, as follows: 1z2x3y4z5x6y7z.

As these examples illustrate, when the dimensions x, y, and z are assigned to bits in the product P, bits in the complement C, columns in the diamond structure, and rows in the diamond structure, when the third dimension (e.g., z) is reached, the repeating nature of the dimensions causing the next assigned dimension to be x. As a result, the three dimensions may be assigned to any number of values.

As described above, embodiments of the present invention may use a recursive method to factorize the product P. In particular, a recursive method may be used to fill the diamond structure with 1s and 0s until all cells in the diamond structure are filled with values, at which point the values in the top row of the diamond structure represent one of the multiplicands of the product P and the values in the right column of the diamond structure represent the other multiplicand of the product P. Therefore, filling the diamond structure with values factorizes the product P.

Referring to FIG. 2B, a first recursion of the recursive method begins with the leftmost bit of the product P (i.e., 1 in the example of FIG. 2B), the leftmost bit of the complement C (i.e., 1 in the example of FIG. 2B), and at the four corners of the diamond structure. The first step of the first recursion involves using the current (e.g., leftmost) bit of the product P to fill (i.e., replace) certain “1” values in the diamond structure. In particular, the first step includes copying the value of the current (i.e., leftmost) bit of the product P into the positions (i.e., four corners) of the diamond structure. As shown in FIG. 2B, because the value of the current (i.e., leftmost) bit of the product P is 1, this value is copied into the four corners of the diamond structure, as illustrated in FIG. 2B by the fact that the four corners of the diamond structure are illustrated in black.

Next, the values that were just copied into the diamond structure (i.e., the is at positions 202a, 202b, 202c, and 202d in FIG. 2B) are subtracted from the corresponding positions of product P to produce a modified product P. In the example of FIG. 2B, this consists of subtracting the 1 at position 202d from the 1x bit of the product, subtracting the two is at positions 202b and 202c from the 7x bit of the product, and subtracting the 1 at position 202a from the 13x bit of the product P. The resulting modified product P is shown in FIG. 2C as +1+1−1−1−1+1−1+1+1−1+1+1.

The second step of the first recursion involves using the current (e.g., leftmost) bit of the complement C to fill (i.e., replace) certain “−1” values in the diamond structure. In particular, in the second step, the current bit of the complement C is used to fill the cells of the diamond structure that are shown in FIG. 2B as being connected to positions 202a, 202b, and 202c by solid lines, namely positions 202e, 202f, 202g, 202h, and 202i. Recall that the complement C is the sum of the 0s in the partial products of the multiplicands. As shown in FIG. 2B, the current (i.e., leftmost) bit of the complement C is 1, which represents a bit in the diamond structure. Therefore, a −1 is copied into position 202g, as shown in FIG. 2B.

According to the “parallel rule”: (1) any row in the diamond structure that contains a −1 must contain all −1s; and (2) any diagonal column (i.e., cells having the same bit position in each row) in the diagonal structure that begins with a −1 must contain all −1s.

Therefore, since position 202e and 202g now contain a −1 due to the value from the first digit of the complement C, by parts (1) and (2) of the parallel rule position 202f must also contain a −1, by part (1) of the parallel rule position 202i must also contain a −1, and by part (2) of the parallel rule position 202h must also contain a −1. Therefore, as shown in FIG. 2B, the value of −1 is copied into positions 202f, 202h, and 202i.

Next, the values that were just copied into the diamond structure (i.e., the 0s at positions 202e, 202f, 202g, 202h, and 202i) are treated as 1s and are subtracted from the corresponding positions of complement C to produce a modified product P. In the example of FIG. 2B, this consists of subtracting the two is at positions 202h and 202i from the complement C, subtracting the 1 at position 202f from the complement C, and subtracting the two is at positions 202e and 202g from the complement C. The resulting modified complement C is shown in FIG. 2C as +1+1+1−1+1+1+1+1−1−1+1+1−1.

As shown in FIG. 2C: (1) the parallelogram at the lower left of the diamond structure is expanded by one position upward and one position rightward; (2) the line in the top row of the diamond structure is expanded by one position rightward; and (3) the line in the right diagonal column of the diamond structure is expanded by one position up and to the right.

The process described above is then performed again to fill the new positions shown in FIG. 2C (i.e., positions 202j, 202k, 202l, 202m, 202n, 202o, and 202p), based on the new product produced above and the new complement C produced above. The results of performing this process are shown in FIG. 2C by the value of 1 filled in cell 202j, the value of −1 filled in cell 202k, the value of 1 filled in cell 202l, the value of −1 filled in cell 202m, the value of 1 filled in cell 202n, the value of 1 filled in cell 202o, and the value of 1 filled in cell 202p.

FIGS. 2D-2G show the remaining recursions of the process described above. In particular, FIG. 2G shows the result of performing all recursions of the process to fill the entire diamond structure. The contents of the diamond structure shown in FIG. 2G represent the multiplicands of the original product P. In particular the contents of the top row of the diamond structure (i.e., +1−1+1−1−1+1+1, alternatively represented as 1010011) represent the first of the two multiplicands, and the contents of the rightmost diagonal column of the diamond structure (i.e., +1−1+1+1−1−1+1, alternatively represented as 1011001) represent the second of the two multiplicands.

The same process described herein may be used to factorize any binary number of any length.

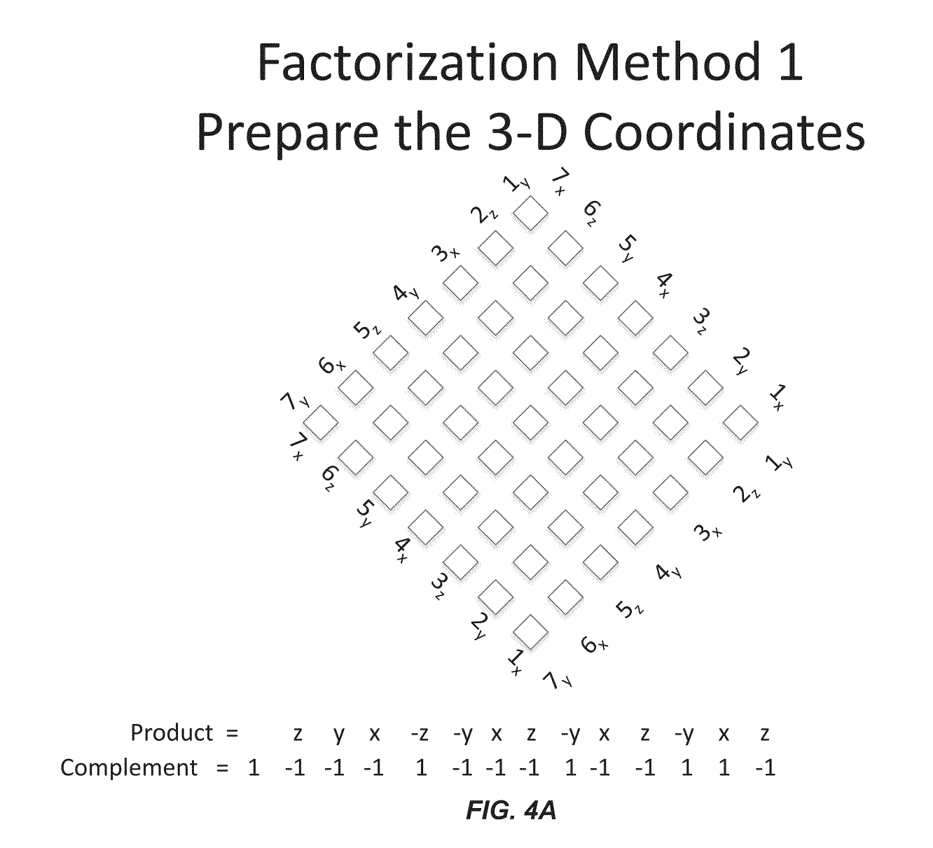

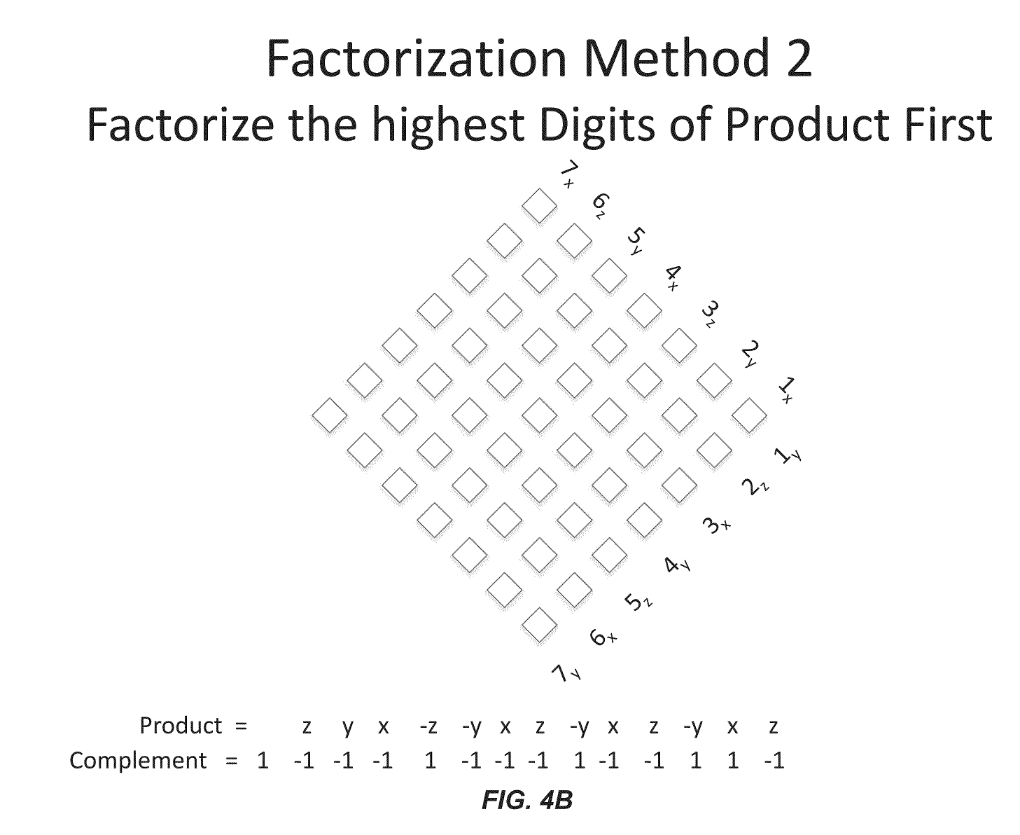

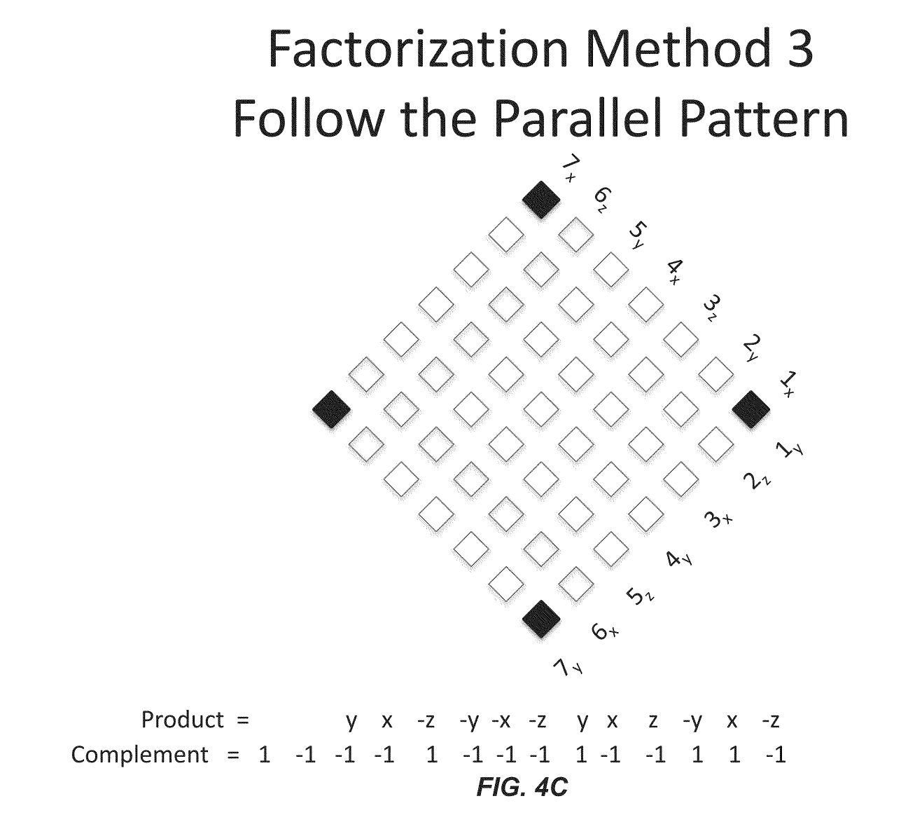

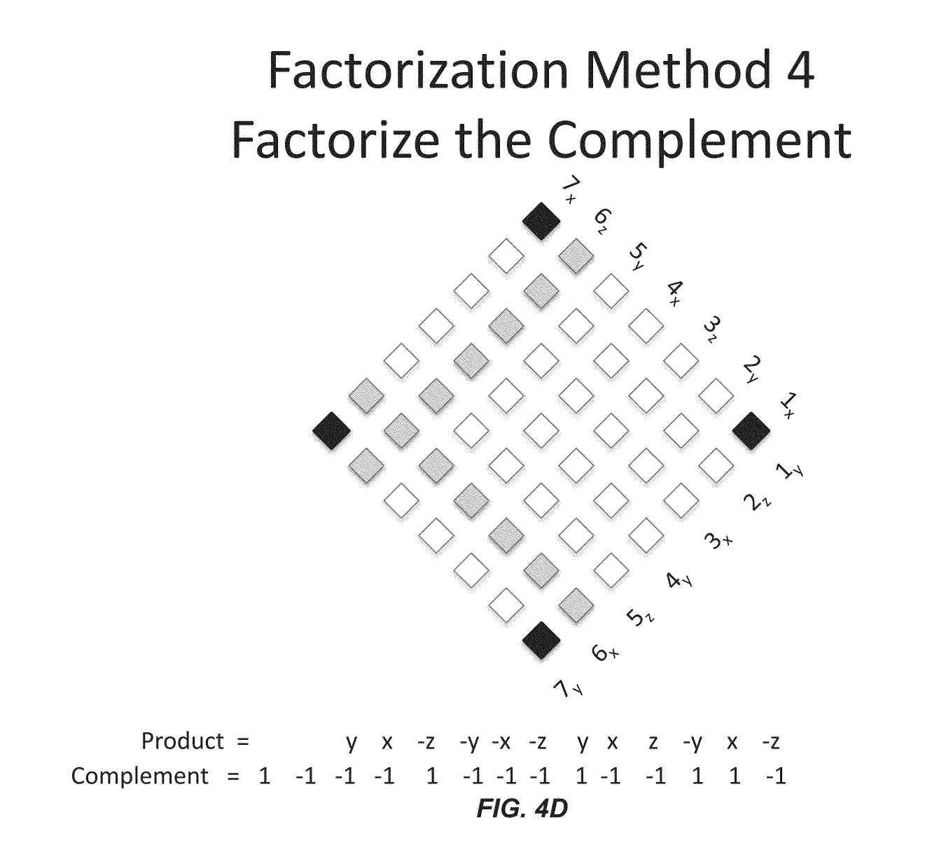

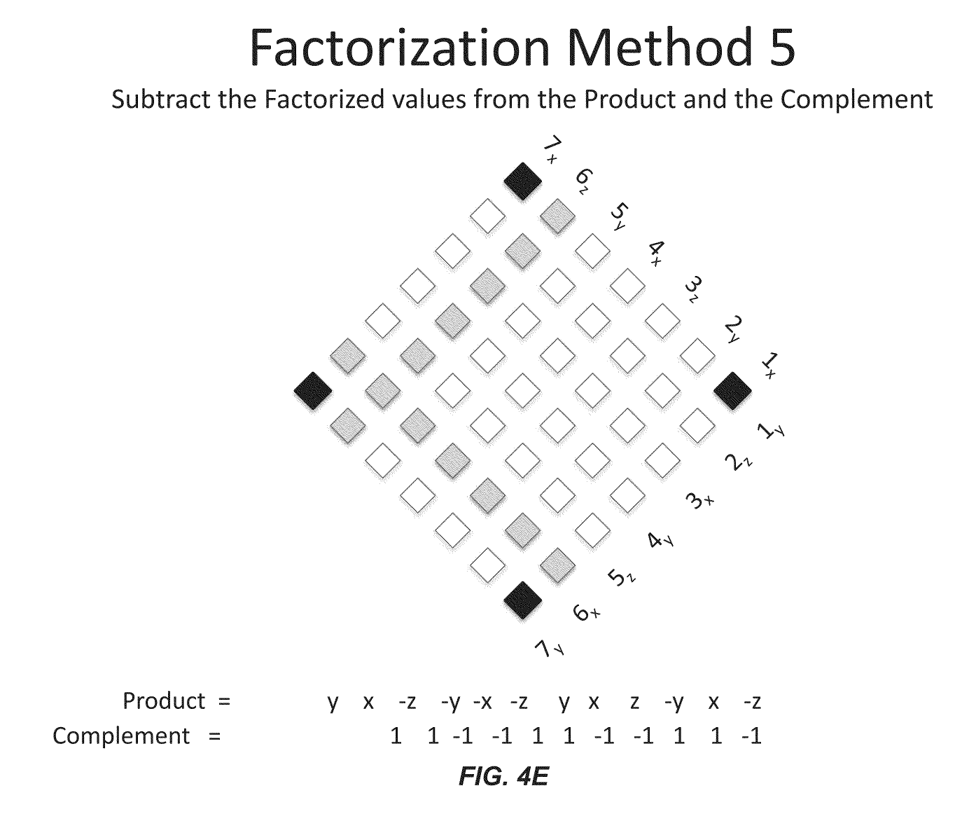

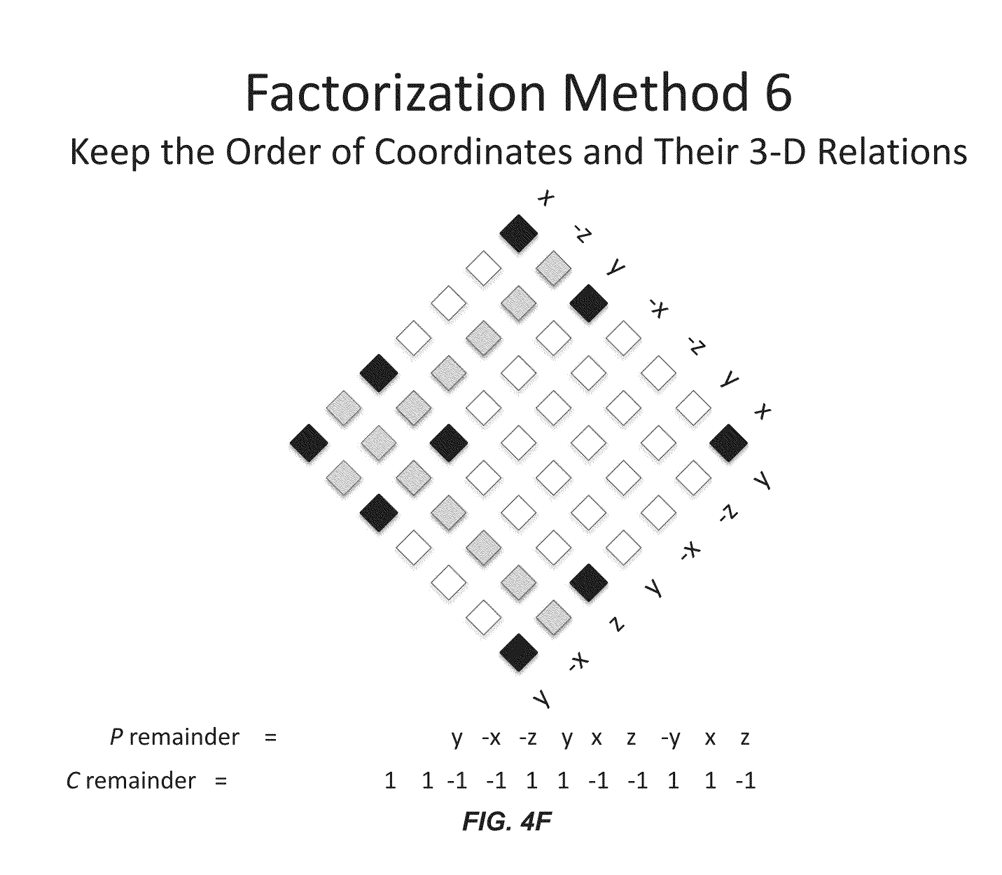

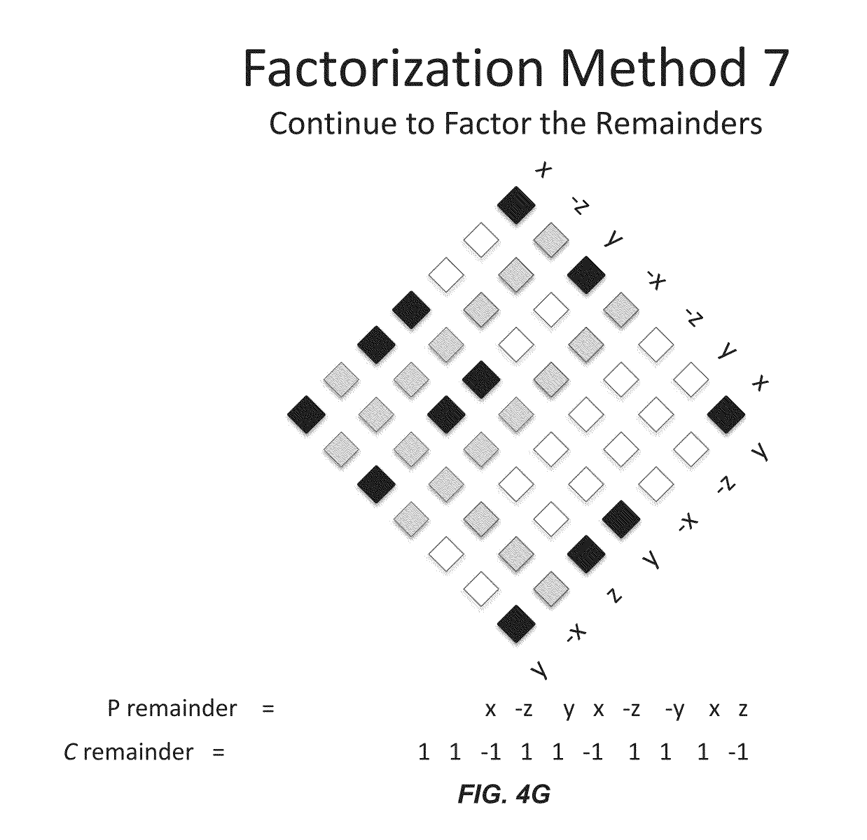

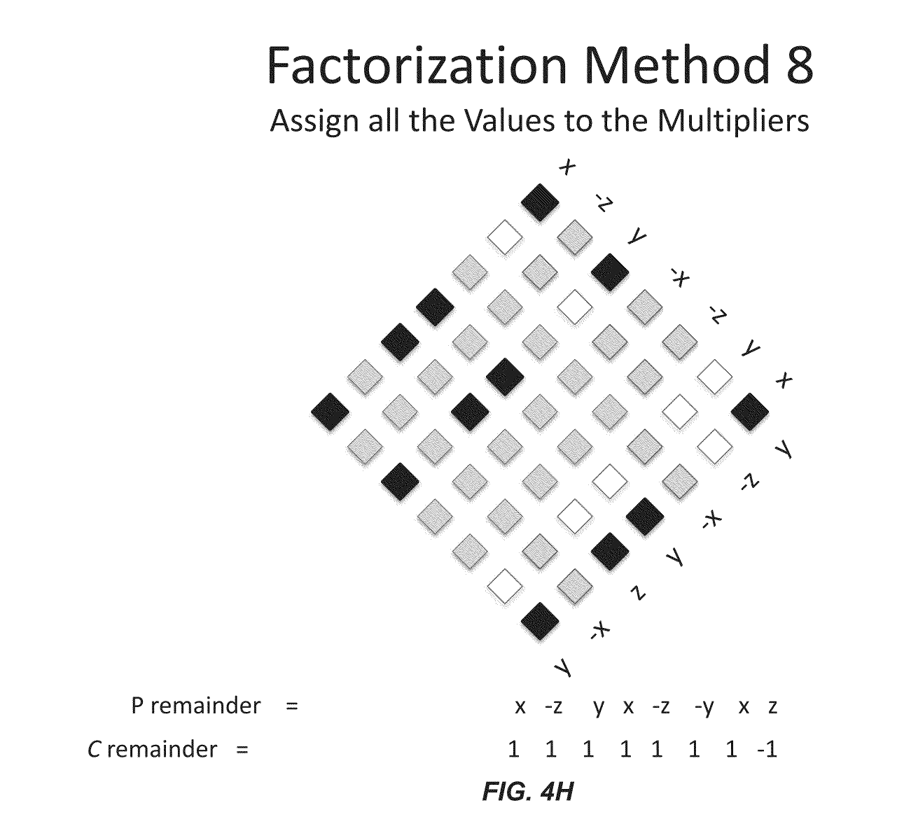

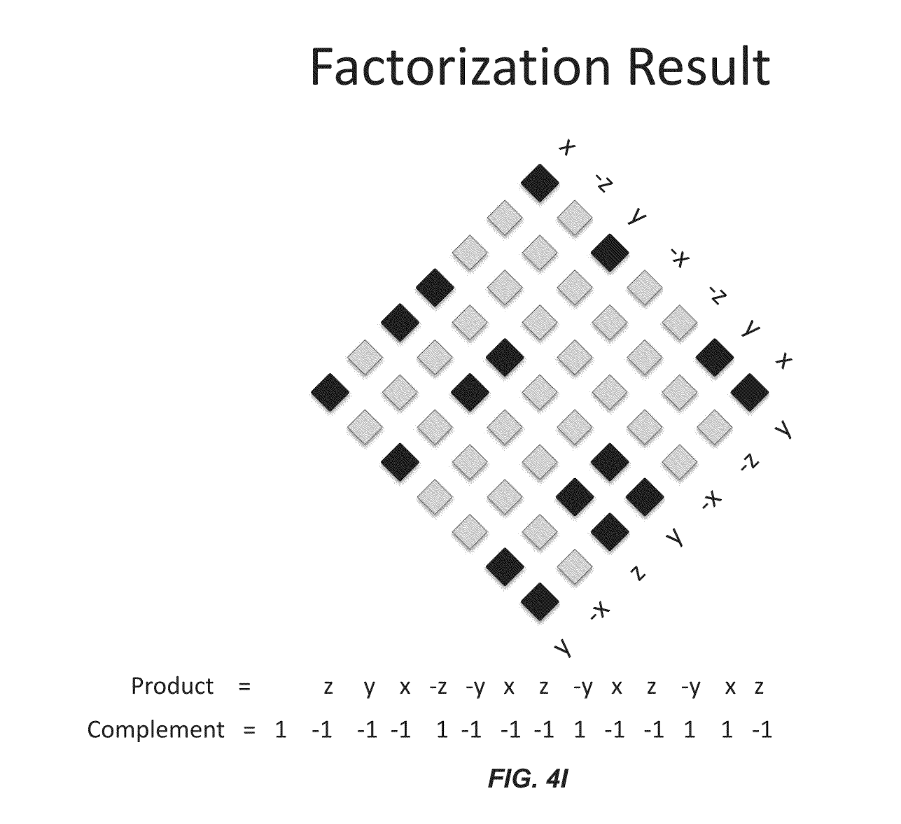

FIGS. 4A-4G illustrate another method of factorization that may be used by embodiments of the present invention. As shown in FIG. 4A, this method begins by preparing the diagonal form, without any values assigned to any elements within the diagonal form. An order for the x, y, and z dimensions is selected. The three-dimensional coordinates are prepared according to the selected order. For example, assume that the order x, y, z is selected. The bits along the top right edge and the bottom left edge of the diamond (which correspond to the first factor), therefore, are assigned to dimensions in the order x, y, z, x, y, z, and so on in a repeating pattern. The bits along the top left edge and the bottom right edge of the diamond (which correspond to the second factor) are assigned to dimensions in an order which ensures that any two vertically-aligned bits are assigned to different dimensions. As shown in FIG. 4A, this results in the bits along the top left edge and the bottom right edge of the diamond being assigned to dimensions in the order y, z, x, y, z, x, and so on in a repeating pattern. Note that this results in any two vertically aligned bits (e.g., 3_{z} and 3ₓ) being assigned to different dimensions.

Finally, dimensions are assigned to each bit of the product, from right to left, in an order that differs from the orders assigned to the first and second factors. As shown in FIG. 4A, this results in the bits of the product being assigned to dimensions in the order z, x, y, z, x, y, and so in in a repeating pattern. Note that this results in any three vertically aligned bits (e.g., 3_{z}, 3ₓ, and 3_{y}) being assigned to distinct dimensions.

In FIG. 4A and the remaining figures, each bit in the product is represented by a dimension label (x, y, or z). A dimension label with a minus sign in front of it (e.g., −y) represents a −1 at the corresponding bit position in the product. A dimension label without a minus sign in front of it (e.g., z) represents a +1 at the corresponding bit position in the product. Therefore, in FIG. 4A, the string zyx-z-yxz-yxz-yxz represents the product +1+1+1−1−1+1+1−1+1+1−1+1+1.

Then, as shown in FIG. 4B, the method factorizes the highest bit of the product. Assuming that the product is an odd number, in the first step of the method, the highest bit of the product can always be factorized to the two bits +1 and +1. These bits are placed into the corresponding bits positions representing the highest bits of the first and second factors in the diagonal pattern, namely the bits in the four corners of the diamond. This result is shown in FIG. 4C.

The method then treats the bits that have been placed into the diamond structure as representing a binary number by summing the bits that were placed into the diamond structure as a result of factoring the current bit in the product to produce a binary number. For example, by summing the four bits that were placed into the diamond structure of FIG. 4C as a result of factoring the first bit of the product along the vertical columns of the diamond structure, the sum +1−1−1−1−1+1−1−1−1−1−1−1+1 (or 1000010000001) is obtained. The method then subtracts this binary number from the current value of the product to obtain a remainder of the product, which is then treated as the current product. The result of this subtraction is shown as the product at the bottom of FIG. 4C.

Then the method determines whether the complement is larger (e.g., is greater than or contains more bits than) the product. If the complement contains is larger than the product, then method places a −1 from the complement into the next bit positions in the diamond structure (e.g., bit positions 6ₓ and 6_{z}). Whenever the method places a −1 into the diamond structure, the method also fills the entire corresponding row/column in the diamond structure with −1s. This is illustrated by the rows/columns of −1s in the 6ₓ and 6_{z} bit positions in the diamond structure in FIG. 4D.

The method then sums the −1s that were placed into the diamond pattern to produce a binary number, and subtracts this binary number from the complement to produce a revised complement which is used in subsequent steps of the method. An example of such a revised complement is shown in FIG. 4E.

The method then iterates in the manner described above. The results of subsequent iterations are shown in FIGS. 4F-4I. Note that if, at any step, the product is larger than the complement, then the current bit positions in the diamond structure are filled with +1s, a binary number is computed from the sum of those +1s along the vertical columns of the diamond structure, and the computed binary number is subtracted from the product to obtain a revised product which is used in subsequent steps of the method.

The final result of the method, as shown in FIG. 41, is a diamond presentation which has been completely filled with 1s and −1s representing the two multiplicands of the product. More specifically, the first multiplicand is represented by the bits along the top right edge of the diamond structure, and the second multiplicand is represented by the bits along the bottom right edge of the diamond structure.

Embodiments of the present invention have a variety of real-world benefits and applications. For example, embodiments of the present invention may be used to factorize numbers in quadratic time for use in the field of cryptography, e.g., to encrypt or decrypt data. As other examples, embodiments of the present invention may be used for weather forecasting, earthquake prediction, and generation of new computing devices. More generally, embodiments of the present invention may be used in any application for which factorization is useful, particular in applications in which highly efficient factorization is useful.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

For example, any of the methods disclosed herein may be performed by a computer which has been programmed to perform such methods. Furthermore, any data disclosed herein (such as binary representations of numbers (e.g., products, factors, and complements) and three-dimensional representations of numbers (e.g., products, factors, and complements)) may be represented in the form of suitable data structures stored in one or more non-transitory computer-readable media. Computer-based implementations of embodiments of the present invention may perform acts on such data in accordance with methods disclosed herein to produce output (such as output representing factors or products). Such output may be stored in a non-transitory computer-readable medium and/or provided as output in any suitable form to a user, such as visual output (e.g., output displayed on a screen). Computer-based implementations of embodiments of the present invention may store data representing any of the elements illustrated in the drawings of the present application, and may provide output (e.g., visual output to a user) representing any of the elements illustrated in the drawings of the present application.

As mentioned above, one of the applications of embodiments of the present invention is cryptography. Such embodiments may be used to perform factorization on numbers having any number of bits. For example, embodiments of the present invention may be used to perform factorization on numbers having 128, 256, 512, 1024, 2048, 4096, 8192, or more bits. One benefit of embodiments of the present invention is that they may perform such factorization in quadratic time. It is particularly useful to use computers to implement embodiments of the present invention because it is entirely infeasible to attempt to factor large numbers without the assistance of computers. Even with the assistance of computers, factoring large numbers can be a difficult problem. Embodiments of the present invention may be used to facilitate factoring of large numbers.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

1. A method performed by at least one computer processor executing computer program instructions stored on a non-transitory computer-readable medium, the method comprising:
(A) selecting an order of x, y, and z dimensions;
(B) representing a product P as a binary number having a first plurality of bits;
(C) creating and storing a mapping of the first plurality of bits to the ordered x, y, and z dimensions in a first repeating pattern;
(E) obtaining a complement C of the product P,
wherein the complement C includes a second plurality of bits;
wherein C=1ₙ²−P;
wherein B is equal to the number of bits in P;
wherein n=(B/2) if B is even;
wherein n=(B+1)/2 if B is odd;
wherein 1n2 is a binary number of length n consisting solely of 1s;
(F) creating and storing a mapping of the second plurality of bits to the ordered x, y, and z dimensions in a second repeating pattern;
(G) constructing an empty diagonal form representation of partial products of a first and second factor of the product P;
(H) recursively filling the diagonal form representation with bits based on the product P and the divider D; and
(I) identifying the first and second factor of the product P based on the filled diagonal form representation.

2. The method of claim 1, wherein the order selected in (A) is x, y, z.

3. The method of claim 1, wherein the order selected in (A) is y, z, x.

4. The method of claim 1, wherein the order selected in (A) is z, x, y.

5. The method of claim 1, wherein (I) comprises identifying the first factor based on a first edge of the diagonal form representation.

6. The method of claim 5, wherein (I) comprises identifying the second factor based on a second edge of the diagonal form representation.

7. The method of claim 1, wherein recursively filling the diagonal form representation in (H) includes a first step comprising copying the value of the leftmost bit of the product P into the four corners of the diagonal form representation.

8. The method of claim 7, wherein (H) includes a second step comprising subtracting the values in the four corners of the diagonal form representation from corresponding bits of the product to produce a modified product.

9. The method of claim 8, wherein (H) includes a third step comprising copying the inverse of the leftmost bit of the complement C into bits in the diagonal form representation which are adjacent to the four corners of the diagonal form representation.

10. The method of claim 9, wherein (H) includes a fourth step comprising applying a parallel rule to the diagonal form representation, wherein the parallel rule specifies that:
any row in the diagonal form representation that contains a zero must contain all zeroes; and
any diagonal column in the diagonal form representation that begins with a zero must contain all zeroes.

11. The method of claim 1, wherein each of the first plurality of bits either has a value of 1 or a value of −1.

12. A non-transitory computer-readable medium comprising computer program instructions executable by at least one computer processor to perform a method, the method comprising:
(A) selecting an order of x, y, and z dimensions;
(B) representing a product P as a binary number having a first plurality of bits;
(C) creating and storing a mapping of the first plurality of bits to the ordered x, y, and z dimensions in a first repeating pattern;
(E) obtaining a complement C of the product P,
wherein the complement C includes a second plurality of bits;
wherein C=1ₙ²−P;
wherein B is equal to the number of bits in P;
wherein n=(B/2) if B is even;
wherein n=(B+1)/2 if B is odd;
wherein 1n2 is a binary number of length n consisting solely of 1s;
(F) creating and storing a mapping of the second plurality of bits to the ordered x, y, and z dimensions in a second repeating pattern;
(G) constructing an empty diagonal form representation of partial products of a first and second factor of the product P;
(H) recursively filling the diagonal form representation with bits based on the product P and the divider D; and
(I) identifying the first and second factor of the product P based on the filled diagonal form representation.

13. A method performed by at least one computer processor executing computer program instructions stored on a non-transitory computer-readable medium, the method comprising:
(A) selecting an order of x, y, and z dimensions;
(B) representing a number N as a binary number having a first plurality of bits;
(C) creating and storing a mapping of the first plurality of bits to the ordered x, y, and z dimensions in a first repeating pattern;
(D) creating and storing a three-dimensional representation of the binary number based on the mapping of the first plurality of bits to the ordered x, y, and z dimensions in the first repeating pattern; and
(E) performing an arithmetic operation on the binary number based on the three-dimensional representation of the binary number.

14. The method of claim 13, wherein each of the first plurality of bits either has a value of 1 or a value of −1.

15. A non-transitory computer-readable medium comprising computer program instructions executable by at least one computer processor to perform a method, the method comprising:
(A) selecting an order of x, y, and z dimensions;
(B) representing a number N as a binary number having a first plurality of bits;
(C) creating and storing a mapping of the first plurality of bits to the ordered x, y, and z dimensions in a first repeating pattern;
(D) creating and storing a three-dimensional representation of the binary number based on the mapping of the first plurality of bits to the ordered x, y, and z dimensions in the first repeating pattern; and
(E) performing an arithmetic operation on the binary number based on the three-dimensional representation of the binary number.
